(19) United States
(12) Patent Application Publication
(10) Pub. No.: US 2025/0297632 A1
(43) Pub. Date: Sep. 25, 2025

(54) PRE-APPLIED SEALANT TO FASTENERS AND/OR BRACKETS FOR MOUNTING SOLAR PANEL MODULES

(71) Applicant: Unirac, Inc., Albuquerque, NM (US)

(72) Inventors: Nicolas Martinez, Albuquerque, NM (US); Joseph Davis, Albuquerque, NM (US); Klaus Nicolaedis, Albuquerque, NM (US); Todd Ganshaw, Albuquerque, NM (US)

(21) Appl. No.: 19/085,521

(22) Filed: Mar. 20, 2025

Related U.S. Application Data
(60) Provisional application No. 63/568,366, filed on Mar. 21, 2024.
(60) Provisional application No. 63/688,192, filed on Aug. 28, 2024.

(51) Int. Cl. F16B 33/00; C09D 5/34; F16B 43/00; F24S 25/60; F24S 25/61; H02S 20/23

(52) U.S. Cl. CPC F16B 33/004; C09D 5/34; F16B 43/001; H02S 20/23; F24S 2025/6005; F24S 25/61

(57) ABSTRACT

Collated fasteners include a strip having a plurality of receptacles and a plurality of fasteners attached to the strip. Individual fasteners of the plurality of fasteners are disposed within individual receptacles of the plurality of receptacles. A sealant is disposed along at least a portion of a length of the individual fasteners. A washer is attached to the individual fasteners. The washer includes a first portion formed of a first material and a second portion formed of a second material.

### CROSS-REFERENCE TO RELATED APPLICATIONS

This application claims priority to U.S. Provisional Application No. 63/568,366, filed Mar. 21, 2024, entitled “Flashing-less Attachment Apparatus and Methods Therefor,” and U.S. Provisional Application No. 63/688,192, filed Aug. 28, 2024, entitled “Collated Fasteners with Pre-Applied Sealant,” the entireties of which are herein incorporated by reference.

### BACKGROUND

The solar power industry continues to grow and, as a result, installation time and integrity remain critical. Generally, mounts secure solar panel modules to a surface using fasteners. Moreover, to prevent an ingress of liquid into the surface, sealant is often disposed around the mount. However, oftentimes, the sealant fails to adequately seal the mount to the surface, around the fasteners, and/or an excessive amount of sealant is used to seal the mount to the surface, resulting in needless waste and expense.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features. The systems depicted in the accompanying figures are not to scale and components within the figures may be depicted not to scale with each other.

FIG. 1 illustrates an example fastener with a pre-applied sealant to seal a bracket to a surface, according to an embodiment of the present disclosure.

FIG. 2 illustrates an example use of the fastener with the pre-applied sealant of FIG. 1, according to an embodiment of the present disclosure.

FIG. 3 illustrates a cross-sectional view of the fastener with the pre-applied sealant, taken along line A-A of FIG. 2, showing a sequence to form a seal between the fastener, the bracket, and the surface, according to an embodiment of the present disclosure.

FIG. 4 illustrates an example aperture of the bracket of FIG. 1 to receive the fastener with the pre-applied sealant, according to an embodiment of the present disclosure.

FIG. 5 illustrates an example faster with a pre-applied sealant usable with the bracket of FIG. 1, according to an embodiment of the present disclosure.

FIG. 6 illustrates an example bracket with a pre-applied sealant, showing bowls of the bracket in a first position, according to an embodiment of the present disclosure.

FIG. 7 illustrates the bracket of FIG. 6, showing the bowls of the bracket in a second position, according to an embodiment of the present disclosure.

FIG. 8 illustrates a detailed view of one of the bowls of the bracket of FIG. 6, according to an embodiment of the present disclosure.

FIG. 9 illustrates cross-sectional views of the bracket, taken along line B-B and line C-C of FIGS. 6 and 7, respectively, showing a transition of the bowls from the first position to the second position, according to an embodiment of the present disclosure.

FIG. 10 illustrates an example bracket with pre-applied sealant and fasteners, according to an embodiment of the present disclosure.

FIG. 11 illustrates a side view of the bracket with the pre-applied sealant and the fasteners of FIG. 10, according to an embodiment of the present disclosure.

FIG. 12 illustrates a cross-sectional view of the bracket with the pre-applied sealant and the fasteners of FIG. 10, taken along line D-D of FIG. 11, according to an embodiment of the present disclosure.

FIG. 13 illustrates an example sequence for securing the bracket of FIG. 10 to a surface, according to an embodiment of the present disclosure.

FIG. 14 illustrates an alternative example of a fastener usable with the bracket of FIG. 10, according to an embodiment of the present disclosure.

FIG. 15 illustrates an alternative example of a fastener usable with the bracket of FIG. 10, according to an embodiment of the present disclosure.

FIG. 16 illustrates example collated fasteners to secure a bracket to a surface, according to an embodiment of the present disclosure.

FIG. 17 illustrates a detailed view of an example fastener of the collated fasteners of FIG. 16, according to an embodiment of the present disclosure.

FIG. 18 illustrates a detailed view of an example washer and an example container to hold a sealant that provides a watertight seal between the collated fasteners of FIG. 16 and a surface, according to an embodiment of the present disclosure.

FIG. 19 illustrates a top view of the collated fasteners of FIG. 16, according to an embodiment of the present disclosure.

FIG. 20 illustrates a side view of the collated fasteners of FIG. 16, according to an embodiment of the present disclosure.

FIG. 21 illustrates an example coil of the collated fasteners of FIG. 16, according to an embodiment of the present disclosure.

FIG. 22 illustrates an example strip of the collated fasteners of FIG. 16, according to an embodiment of the present disclosure.

FIGS. 23 and 24 illustrate an example sequence for using the collated fasteners of FIG. 16 to secure a bracket to a surface, according to an embodiment of the present disclosure.

FIGS. 25-30 illustrate various examples for securing collated fasteners to a strip, according to an embodiment of the present disclosure.

FIG. 31 illustrates an example collated fastener being used in conjunction with a sealant, according to an embodiment of the present disclosure.

FIG. 32 illustrates an example collated fastener being used in conjunction with a sealant, according to an embodiment of the present disclosure.

FIG. 33 illustrates an example sealant used in conjunction with a collated fastener, according to an embodiment of the present disclosure.

FIG. 34 illustrates an example use of the sealant of FIG. 33 in conjunction with a collated fastener, according to an embodiment of the present disclosure.

FIG. 35 illustrates an example collated fastener with a pre-applied sealant, according to an embodiment of the present disclosure.

FIG. 36 illustrates an example sealant used in conjunction with a collated fastener, according to an embodiment of the present disclosure.

FIG. 37 illustrates an example collated fastener with a pre-applied sealant, according to an embodiment of the present disclosure.

FIG. 38 illustrates an example bracket that may have pre-applied sealant, and/or which may be used with fasteners having pre-applied sealant, according to an embodiment of the present disclosure.

### DETAILED DESCRIPTION

This application is directed, at least in part, to pre-applying a sealant to fasteners and/or brackets used in mounting solar panel modules to a surface, according to an embodiment of the present disclosure. In an embodiment, the sealant may be pre-applied at, along, or to a predetermined portion of the fasteners. Additionally, or alternatively, the sealant may be pre-applied within, or adjacent to, apertures of the brackets through which the fasteners are disposed to secure the bracket to the surface. Regardless of the specific embodiment, as the fasteners are secured into the surface, such as a roof, the sealant may form a seal between, around, etc., the fastener, the bracket, and the surface. Moreover, the sealant may be drawn into penetrations formed in the surface via the fasteners. This has the benefit of sealing the penetrations to prevent an ingress of liquid into the surface. Pre-applying the sealant may reduce installation times, complexities, and/or debris associated with conventional methods.

In an embodiment, the fasteners may represent any suitable fastener, such as a screw, bolt, nail, etc. The fasteners themselves may include any suitable head (e.g., hex, Phillips, standard, etc.) and/or head type (e.g., hex, flanged hex, button, socket head, flanged socket head, etc.) to secure the fasteners into the surface. When embodied as a screw or bolt, for example, the fasteners may include threads (e.g., wood threads). The fasteners may include any suitable length (e.g., 2″, 3″, etc.) and gauge.

The bracket, which may be alternatively referred to as a mount, clamp, system, attachment, etc., may include the apertures through which the fasteners are disposed. In an embodiment, the bracket may include a base with the apertures and a stanchion extending from the base. The stanchion, whether directly or indirectly, may support the solar panel modules. For example, clamps may secure the solar panel modules to the stanchion. Alternatively, a rail may be secured to the stanchion and the solar panel modules may be secured to the rail using other clamps, fasteners, etc. In an embodiment, the bracket may resemble a “T” shaped bracket, whereby the stanchion extends from the base. Alternatively, other styles or shaped brackets may be used. For example, the bracket may include an “L” shape, a “Z” shape, etc.

The base may include one or more of the apertures to secure the bracket to the surface, where individual fasteners are disposed through individual apertures and into the surface. Additionally, more than one of the brackets may be disposed about the surface to support the solar panel modules and secure the solar panel modules to the surface. The surface into which the fasteners are secured may represent any suitable surface and include different layers or materials, etc. For example, the surface may represent a composite shingle roof having one or more layers of shingles, tar paper, sheathing (e.g., OSB, plywood, lap, etc.), rafters, flashing, etc.

When pre-applied to the bracket, the sealant may be disposed within, around, on, etc., the apertures, adjacent to the apertures, and so forth. Regardless of the specific embodiment, as the fasteners are disposed through the apertures and into the surface, the sealant may seal around the penetrations into the surface. In an embodiment, the sealant may at least partially fill the apertures. As the fasteners are driven through the apertures and come in contact with the sealant, the sealant may become entwined with the fasteners and drawn into the surface to create a seal between the bracket, the surface, and the fastener.

In an embodiment, a combination of sealant being pre-applied to the fastener and the sealant being pre-applied to the mount may be used. Although described as being used in conjunction with the bracket, the fasteners with the pre-applied sealant may be used to secure other mechanisms to the surface, may be used to secure other things to the surface rather than solar panel modules, etc.

The sealant may represent any suitable sealant or substance, such as butyl. In an embodiment, the butyl may be in liquid form, tape form, putty form, etc. The sealant may be applied as strips of adhesive along a length of the fastener, at least partially wrapped around the fastener, for example. When embodied as strips of adhesive, the sealant may be applied to a surface of the bracket, for example, adjacent to or over the apertures. As another example, a caulk gun (or other instrument) that dispenses liquid butyl may be used to coat the fastener with the sealant, within the apertures, etc. The sealant may represent a flowable sealant, a liquid sealant, an injectable sealant, or an adhesive sealant.

As introduced above, the sealant may be pre-applied to predetermined portions or lengths of the fasteners. For example, the sealant may be disposed along ⅔, ⅓, etc., of the length of the fasteners. In an embodiment, different lengths of fasteners may be used and the length along which the butyl is disposed may be based on the length of the fastener. The sealant may be applied to the fastener and/or the bracket during manufacturing, at a worksite, for example, prior to installation. The sealant may be a component applied by an installer to the fastener and/or the bracket.

Other examples of the sealant include silicone, acrylic, polyurethane, rubber. Any suitable method may be used to pre-apply, pre-coat, etc., the sealant to the fasteners and/or the brackets. For example, the sealant may be pre-applied to the fasteners and/or the bracket via spraying, dipping, coating, wrapping, etc. Here, the fasteners and/or the brackets may be sprayed with the sealant, dipped in the sealant, etc., to pre-apply the sealant. In an embodiment, the sealant may be heat-activated, UV-activated, etc., to prevent unwanted adhesion to the sealant (e.g., dust, debris, etc.) before installation. For example, during storage or while being transported, the sealant may be non-adhesive (e.g., to avoid collecting debris). Once exposed to the surrounding environment during installation, such as heat, UV light, etc., the sealant may be activated. As another example, the sealant may be applied as microspheres, whereby the sealant is entrapped or encapsulated within the microspheres. Under pressure, such as when the fastener is driven into the surface, the microspheres may break, fracture, etc., to release the sealant. In an embodiment, the microspheres may include different compounds, chemicals (e.g., two-part epoxies), etc., to form a chemical reaction with one another.

In an embodiment, to prevent debris from adhering to the sealant before installation, the sealant may be wrapped with a release paper, membrane, film, etc. The release paper (e.g., wax paper) may prevent inadvertent adhesion with the sealant before installation. For example, the release paper may prevent adhesion between the sealant and/or other fasteners, brackets, etc. Prior to installation, or during installation, the release paper may be removed (e.g., pulled) from the fastener or the bracket. In an embodiment, the disposing the sealant at least partially within the apertures may have the added benefit of protecting the sealant or preventing premature adhesion between the sealant and other components used during installation.

As the fasteners are secured into the surface, the sealant may become embedded in, entangled with, entwined with, wrapped around, etc., the threads of the fastener. This has the effect of advancing the sealant into a hole (e.g., the penetrations) created by the fastener as the fastener is secured into the surface. In an embodiment, holes may be predrilled into the surface, and thereafter, the fasteners may be secured into the surface within the holes. The sealant becomes disposed around the fastener, within the hole and/or external to the hole, to provide a watertight seal. Having the sealant engage the threads as the fastener is fastened to the surface advances the sealant through the different layers of the surface to increase the watertight seal.

In an embodiment, the fasteners may include a washer. The washer may be made of ethylene-propylene diene monomer (EPDM), metal (e.g., stainless steel), or one or more other suitable materials. The washer may assist in forming a watertight seal with the surface. In an embodiment, the washer may include an aperture that has a diameter smaller than a minimum diameter of the fastener. In doing so, the aperture of the washer may stretch around or over the fastener to tightly grip around the fastener, thereby preventing water from flowing between the washer and the fastener. The washer may also have a diameter that is larger than the aperture in the bracket. When the head of the fastener drives against the stainless steel portion of the washer, the stainless steel portion supports the force of the head of the fastener and, at the same time, compresses the EPDM portion around the periphery of the aperture in the bracket to seal the aperture from and ingress of water.

In an embodiment, the fasteners may be separate fasteners that are individually installed or handled to secure the bracket to the surface. Alternatively, in an embodiment, the fasteners may be collated fasteners secured to one another via a strip. For example, individual fasteners of the collated fasteners may be held together via a plastic strip, membrane, etc. In an embodiment, the sealant may be disposed within a container through which at least a portion of the fasteners is disposed. A screw gun may engage the head to drive the fasteners into the surface. As the fasteners are secured into the surface, for example, via the screw gun or other instrument, the sealant may seal between, around, etc., the fastener and the surface. Moreover, as the fasteners are secured to the surface, the fasteners may become separated (e.g., unattached, disconnected, etc.) from the strip. In an embodiment, the screw gun may include a deflector, remover, etc., that removes the release paper prior to installation.

The collated fasteners may be loaded into the screw gun and automatically advanced through the screw gun as the collated fasteners are deposited into the surface. In an embodiment, the screw gun may include a feed mechanism configured to feed the collated fasteners through the screw gun. For example, the feed mechanism may include a wheel that engages with the strip to advance the collated fasteners through the screw gun as the fasteners are deposited into the surface. In an embodiment, the collated fasteners may be wound in a coil, drum, magazine, etc., that is fed through the screw gun. As another example, the collated fasteners may be disposed along the strip that contains a predetermined number of fasteners and which is fed into the screw gun and/or the feed mechanism. Regardless of the specific embodiment, a plurality of the collated fasteners may be secured together along the stip. The strip may also include features (e.g., notches, tabs, etc.) that assist in feeding the strip through the screw gun, or which are engaged by the feed mechanism to advance the strip through the screw gun.

The strip may be manufactured from plastic or other materials and is configured to hold the fasteners together such that the fasteners are capable of being fed through the screw gun. In an embodiment, the strip may include receptacles that receive a portion of the fasteners and/or which secure, attach, etc., the collated fasteners to the strip. However, in an embodiment, the receptacles may be omitted and the fasteners may secure to the strip via being forced (e.g., pushed) through the strip. The strip may include tabs disposed within the receptacle that engage with the fasteners to secure the fasteners to the strip. In an embodiment, the strip may be disposed proximate to a point, a head, or along a length of the body (e.g., between the tip and the head) of the fastener.

The sealant may be pre-applied, pre-installed, pre-coated, etc., on the fasteners disposed on the strip. In an embodiment, the sealant may be applied after the fasteners are attached to the strip, before the fasteners are attached to the strip, and/or while the fasteners are attached to the strip. As introduced above, in an embodiment, the sealant may be disposed in the container that is attached to, or integrated with, the strip. Alternatively, the container may be separate from the strip. Disposing the sealant within the container may cover, enclose, etc., the sealant to avoid the sealant inadvertently adhering to other surfaces, attracting debris, etc. before installation, similar to the use of the release paper as described above. For example, the container may be made of plastic that encases the sealant. The container may also be manufactured from a biodegradable material (e.g., bagasse, bamboo, fibers, etc.). Additionally, the container may include any shape, such as conical, cylindrical, hexagonal, etc.

In an embodiment, a portion of the fastener may be disposed through the container to engage or contact the sealant at a location within (e.g., internal to) the container. For example, the sealant may be adhered to the fastener at a location within the container. A tip of the fastener may be disposed external to the container such that the collated fastener (e.g., at the tip) may be aligned adjacent to the aperture in the bracket. As the fastener is driven into the surface, the sealant may be drawn out of the container through an engagement with the threads of the fastener. Once secured to the surface, the fastener may be separated from the strip. In an embodiment, the container may become compressed or squeezed between the head of the fastener, the washer, and the bracket when secured into the surface, causing the container to collapse, buckle, etc. However, in an embodiment, rather than collapsing the container, the fastener may be fully advanced through the container. However, in an embodiment, the container may be omitted and the sealant may be disposed along a length of the fasteners. A release paper may surround the sealant to prevent inadvertent adhesion.

The container may include one or more openings, passageways, etc., through which the fastener is at least partially disposed. The openings also permit the sealant to exit the container when the fastener is secured into the surface. The container may include one or more tabs that engage with the fastener at a location within the openings to secure the container to the fastener. For example, the fastener may be pushed at least partially through the container. The tabs engage with sides/surfaces of the fastener to secure the container to the collated fastener. In an embodiment, the sealant may be disposed within the container before or after the container is secured to the collated fastener. When disposed in the container beforehand, the tip of the fastener may be pushed through the sealant, and the sealant may remain in the container. In an embodiment, the container may be disposed more proximate to the tip of the collated fastener than the head. As also introduced above, washers may assist in forming a watertight seal with the surface.

In an embodiment, the strip connecting the fasteners may be disposed proximate to the head of the fasteners. The container may be secured to the strip or integrated with the strip, whether above the strip and immediately adjacent to the head (e.g., disposed between the head and the strip) or below the strip (e.g., between the tip and the strip). Alternatively, the container may be separate from the strip, disposed above the strip, below the strip, etc. Still, although described as including a strip that connects the fasteners, belts, connectors, etc., may be used to connect the fasteners together. Additionally, in an embodiment, the containers may be connected to one another via a separate strip.

In an embodiment, the fasteners may be pre-installed to or on the bracket. For example, an end (e.g., tip) of the fastener may be disposed within the apertures of the bracket and held in place via an engagement with the sealant. In an embodiment, the bracket may include embossed features disposed around the apertures, or which at least partially define the apertures, to contain the sealant. An engagement with the sealant may maintain an orientation of the fasteners before installation. At the time of installation, given that the fasteners are already pre-installed on, or to, the bracket, installation times may be reduced. As similarly discussed above, as the fasteners are driven into the surface, the sealant may form a seal around the penetrations into the roof.

Compared to conventional techniques, pre-applying the sealant may reduce installation times, complexities, waste, damage, injury, and so forth. For example, conventionally, sealant is applied during installation. This requires additional tools, instruments, etc., to be transported to the surface. In addition, the sealant is often messy and difficult to handle during installation. Applying the sealant to the fasteners and/or the bracket ahead of time may also reduce waste, for example, by placing the sealant at the locations corresponding to penetrations into the surface. This is compared to applying the sealant across an entirety of the bracket, or a surface thereof, in contact with the surface. Pre-applying the sealant has the benefit of reducing these troubles while reducing the amount of time installers spend on the surface.

The present disclosure provides an overall understanding of the principles of the structure, function, device, and system disclosed herein. One or more examples of the present disclosure are illustrated in the accompanying drawings. Those of ordinary skill in the art will understand and appreciate that the devices, the systems, and/or the methods specifically described herein and illustrated in the accompanying drawings are non-limiting embodiments. The features illustrated or described in connection with one embodiment or instance may be combined with the features of other embodiments or instances. Such modifications and variations are intended to be included within the scope of the disclosure and appended claims.

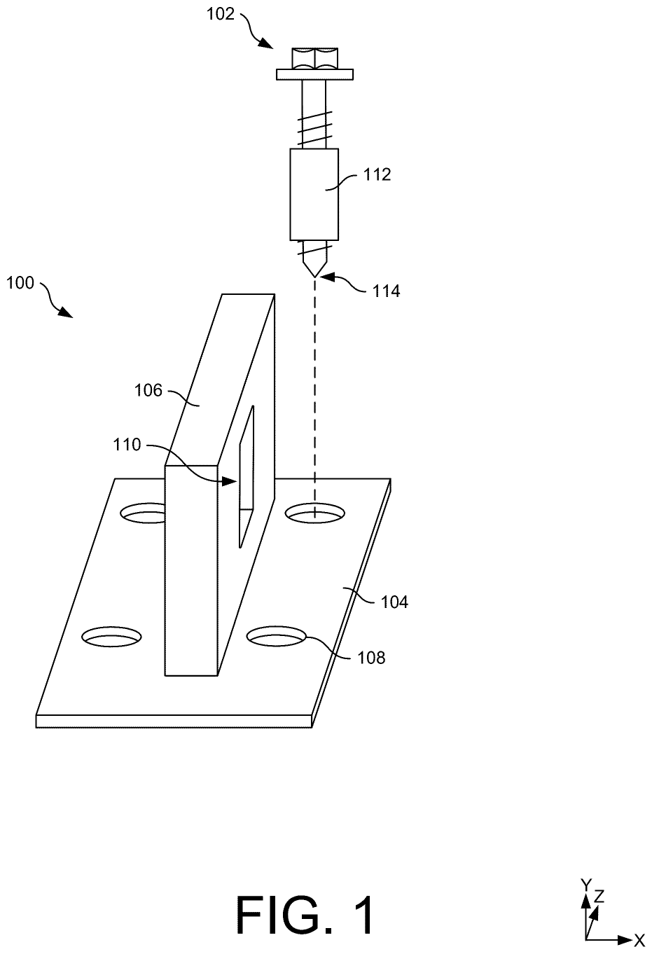

FIG. 1 illustrates a bracket 100 configured to be secured to a surface via fasteners 102 (or individually “fastener 102”), according to an embodiment of the present disclosure. The bracket 100 may include a base 104 and a stanchion 106 extending from the base 104. The base 104 may include apertures 108 (or individually “aperture 108”) through which the fasteners 102 are disposed. For example, the fasteners 102 may be disposed through the apertures 108 and into the surface for securing the bracket 100 to the surface. The base 104 may define one or more of the apertures 108. Although a particular arrangement of the apertures 108 is shown, other embodiments are envisioned. Additionally, although FIG. 1 illustrates one of the fasteners 102, the fasteners 102 may be disposed through individual apertures of the apertures 108. Still, although FIG. 1 illustrates a particular style of the bracket 100, such as a “T” shaped bracket, other brackets may be used. As an example, the bracket 100 may be “Z” shaped, “L” shaped, and so forth. In such instances, the bracket 100 may include one or more of the apertures 108. In an embodiment where the bracket 100 is “L” shaped, the bracket 100 may include one of the apertures 108.

The stanchion 106 extends above the base 104 and is used to secure solar panel modules to the surface. For example, the stanchion 106 may include a channel 110 through which fasteners are disposed. The fasteners disposed through the channel 110 may be used to secure mounts, clamps, rails, etc., to the stanchion 106. These mounts, clamps, rails, etc., may additionally secure to the solar panel models, whether directly or indirectly. Regardless of the specific embodiment, the bracket 100, whether directly or indirectly (e.g., via rails attached to the stanchion 106) may be used to secure the solar panel modules to the surface. A plurality of the brackets 100 may be secured into the surface for supporting the solar panel modules.

The fasteners 102 are shown having a sealant 112, which may be pre-applied to a portion of a length of the fasteners 102. The sealant 112 may be pre-applied to the fastener 102 prior to fastening the fasteners 102 into the surface. As the fastener 102 is driven into the surface, the sealant 112 may seal around the apertures 108, holes or penetrations in the surface created via the fastener 102, and so forth. This prevents an ingress of liquid (e.g., water) into the surface. The sealant 112 therefore seals the bracket 100 against the surface. In an embodiment, the sealant 112 may be disposed proximate to a tip 114 of the fastener 102 in order to be pulled into the surface as the fastener 102 is driven into the surface.

The sealant 112 may represent any suitable sealant, such as butyl, silicon, acrylic, polyurethane, rubber, etc. In an embodiment, the sealant 112 may be in liquid form, tape form, putty form, etc. Any suitable method may be used to pre-apply, pre-coat, etc., the fasteners 102 with the sealant 112. For example, the sealant 112 may be applied as strips of adhesive along a length of the fastener 102, at least partially wrapped around the fastener 102. As another example, a caulk gun may be used to dispense the sealant 112 to coat the fastener 102 with the sealant 112. However, the sealant 112 may be pre-applied to the fasteners 102 via spraying, dipping, coating, wrapping, etc. The sealant 112 may represent a flowable sealant, a liquid sealant, an injectable sealant, or an adhesive sealant.

In an embodiment, the sealant 112 may be heat-activated, UV-activated, etc., to prevent unwanted adhesion of the sealant 112 (e.g., dust, debris, etc.) before installation. For example, during storage or while being transported, the sealant 112 may be non-adhesive (e.g., to avoid collecting debris). Once exposed to the surrounding environment during installation, the sealant 112 may be activated via heat, UV light, etc. As yet another example, the sealant 112 may be applied as microspheres to the fastener 102, whereby the sealant 112 is entrapped or encapsulated within the microspheres. Under pressure, such as when the fastener 102 is driven into the surface, the microspheres may break, fracture, etc., to release the sealant 112 to form the seal. In an embodiment, the microspheres may include different compounds, chemicals (e.g., two-part epoxies), etc., to form a chemical reaction with one another, with air, with heat, etc., to form the seal.

In an embodiment, to prevent debris from adhering to the sealant 112 before installation, the sealant 112 may be wrapped with a release paper, membrane, film, etc. The release paper may prevent inadvertent adhesion with the sealant 112 before installation. For example, the release paper may prevent adhesion between the sealant 112 and other fasteners, brackets, etc., during transport. Prior to installation or during installation, the release paper may be removed.

Although described as being used in conjunction to secure solar panel modules to a surface, the bracket 100 and/or the fasteners 102 may be used for other purposes and/or for securing other components to the surface. Still, the fasteners 102 may be used in conjunction with other mounts, frames, etc., secured to a surface, whether for supporting solar panel modules or other components. Additionally, although the solar panel modules are described as being secured to the stanchion 106 via the channel 110, other holes, slots, members, etc., may be used to secure the solar panel modules, whether directly or indirectly, to the bracket 100.

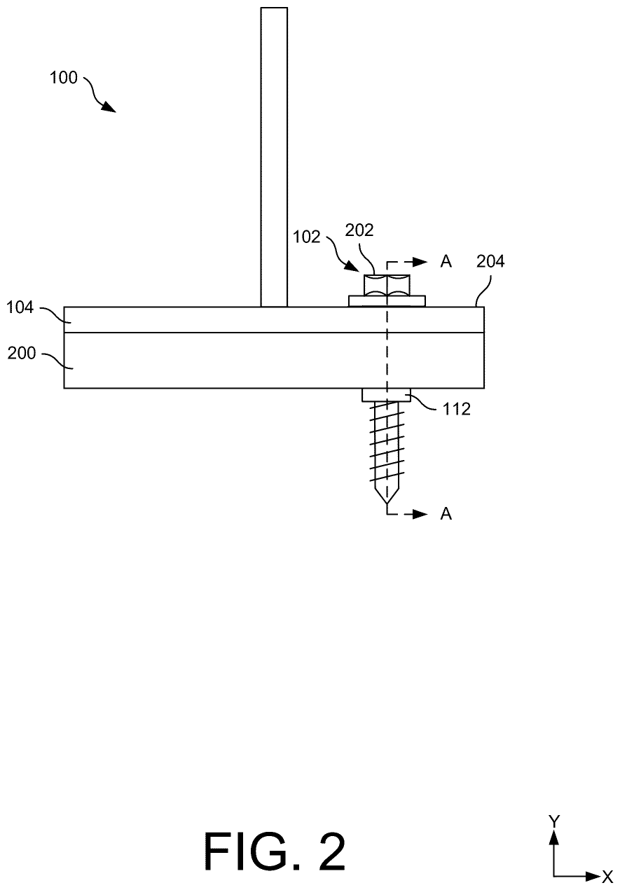

FIG. 2 illustrates a side view of the bracket 100 of FIG. 1, showing the fastener 102 disposed through the aperture 108 and into a surface 200, according to an embodiment of the present disclosure. When disposed through the aperture 108, a head 202 of the fastener 102 may be disposed adjacent to a top 204 of the base 104. Moreover, a washer or integrated flange (e.g., flange head) may be used additionally seal the fastener 102 against the base 104.

As shown, the fastener 102 is driven into the surface 200, which may include or represent trusses, fasters, structural members, sheathing, OSB, etc. As the fastener 102 is driven into the surface 200, the sealant 112 is pulled into the surface 200 to seal a penetration formed in the surface 200 via the fastener 102. The sealant 112 may also occupy a portion of the aperture 108, areas between the bracket 100 (or the base 104) and the surface 200, between the head 202 and the top 204 of the bracket 100, etc. More particularly, as the fasteners 102 are secured into the surface 200, the sealant 112 may become embedded in, entangled with, entwined with, wrapped around, etc., the threads of the fastener 102. This has the effect of advancing the sealant 112 into the surface 200 as the fastener 102 is secured into the surface 200. The sealant 112 becomes disposed around the fastener 102, within the hole and/or external to the hole in the surface 200, to provide a watertight seal.

Although the surface 200 is shown including a single layer, the surface 200 may include multiple layers, and/or the fastener 102 may be disposed through intermediary layers before securing into the surface 200. These intermediary layers may include shingles (e.g., composite shingles), flashing, tar paper, ice block, etc. Regardless of the number of layers, the sealant 112 may be drawn into the surface, or entwined with the fastener 102, to seal around the penetrations.

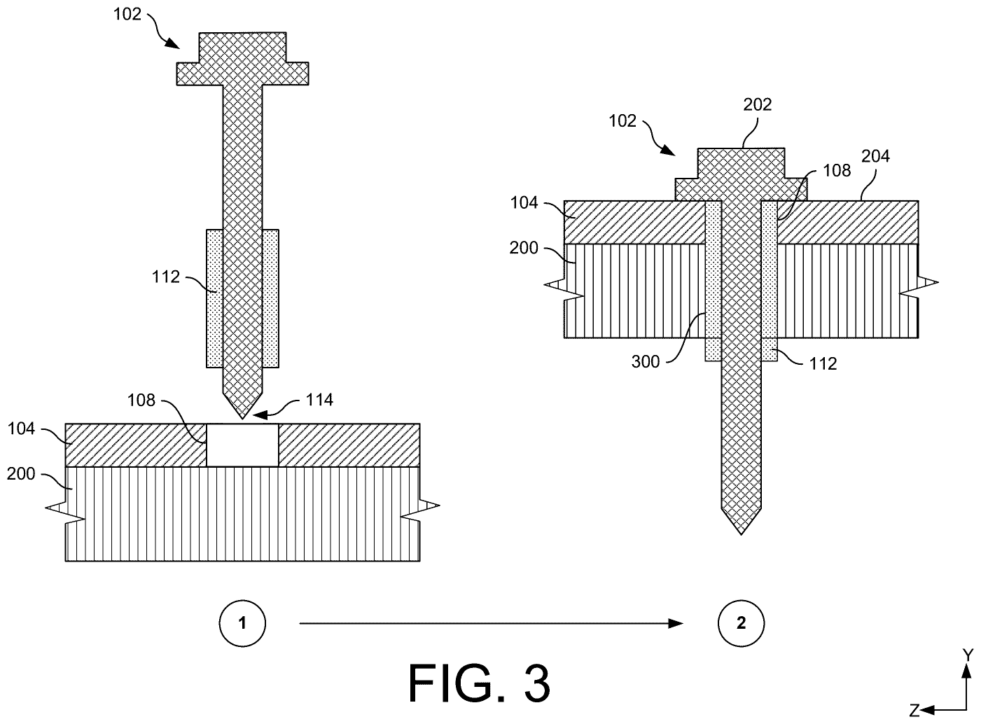

FIG. 3 illustrates a cross-section view of the bracket 100, the fastener 102, and the surface 200, taken along line A-A of FIG. 2, according to an embodiment of the present disclosure. FIG. 3 illustrates an example sequence to secure the bracket 100 to the surface 200 using the fastener 102.

At “1” in FIG. 3, the bracket 100 is shown being disposed on the surface 200. For example, a bottom of the base 104 (or more generally, the bracket 100) may be disposed on the surface 200. The fastener 102, such as the tip 114 of the fastener 102, may be disposed adjacent to the aperture 108. Moreover, the sealant 112 is shown being disposed along at least a portion of the length of the fastener 102 to seal the surface 200 and prevent an ingress of liquid into penetrations formed in the surface 200 via the fastener 102. As shown, the sealant 112 may be disposed adjacent to the tip 114 of the fastener 102 such that the sealant 112 is capable of being drawn into the surface 200.

In an embodiment, the aperture 108 may be cylindrically shaped (e.g., about the Y-axis). The aperture 108 may have a constant diameter or a varied diameter. Moreover, the aperture 108 may include shapes other than cylindrical.

At “2” in FIG. 3, the fastener 102 is shown being disposed, or driven, into the surface 200. As the fastener 102 is disposed into the surface 200, the sealant 112, via an engagement with the threads, for example, becomes disposed or drawn into the surface 200. This seals the fastener 102 within a penetration 300 formed in the surface 200. In addition, the sealant 112 may be disposed within the aperture 108 to prevent a flow of liquid through the aperture 108 and into the penetration 300. Although not shown, the sealant 112 may additionally be disposed between the base 104 (e.g., a bottom of the base 104) and the surface 200 (e.g., a top of the surface 200). This may further seal the bracket 100 against the surface 200 to prevent an ingress of liquid into the penetration 300. The penetration 300 may include a different or similar size (e.g., cross-sectional dimension in the Z-direction as shown in FIG. 3) than the aperture 108.

Although not shown, a washer may be used to further seal the aperture 108 and/or the penetration 300. The washer may include an EPDM washer, a metal washer, and or one or more other suitable materials. When the head 202 of the fastener 102 drives against the stainless steel portion of the washer, the stainless steel portion supports the force of the head 202 of the fastener 102 and, at the same time, compresses the EPDM portion around the periphery of the aperture 108 to seal the aperture 108.

In an embodiment, the sealant 112 may create a localized seal around the penetration 300. Sealing around the penetration 300 may avoid waste and increase the speed at which the bracket 100 is attached to the surface 200. This is compared to conventional techniques whereby a sealant may be disposed along an entire interface between the bracket 100 and the surface 200, such as along an entirety of the bottom of the bracket 100 in contact with the surface 200.

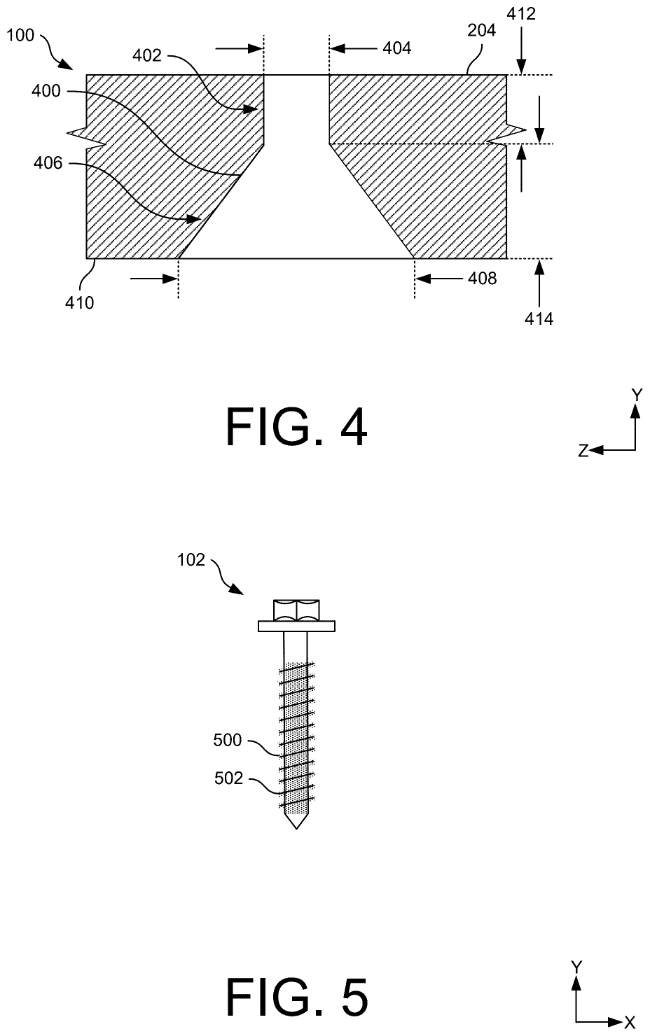

FIG. 4 illustrates an alternate shape of an aperture 400 of the bracket 100, according to an embodiment of the present disclosure. In an embodiment, the bracket 100 may include the aperture 400 in lieu of, or in addition to, the aperture 108. As shown, the aperture 400 may include a first portion 402 having a first cross-sectional dimension 404 and a second portion 406 having a second cross-sectional dimension 408 that is larger than the first cross-sectional dimension 404. The first cross-sectional dimension 404 may be disposed along the top 204 of the bracket 100, while the second cross-sectional dimension 408 may be disposed along a bottom 410 of the bracket 100. In an embodiment, the first cross-sectional dimension 404 may be sized to receive the sealant 112 pre-applied to the fastener 102. The aperture 400 may taper between the first cross-sectional dimension 404 and the second cross-sectional dimension 408. The first portion 402 may extend a first distance 412 between the top 204 and the bottom 410, while the second portion 406 may extend a second distance 414 between the top 204 and the bottom 410. The second distance 414 may be longer than the first distance 412.

The shape of the aperture 400 may promote the flow of the sealant 112 against the surface 200 and/or into the penetration 300. For example, the conical nature of the aperture 400 may funnel the sealant 112 against such that the sealant 112 is entwined with the fastener 102 and advanced into the surface 200 and/or against the surface 200. Although a particular shape of the aperture 108 and/or the aperture 400 is shown, other shapes are envisioned.

FIG. 5 illustrates the fastener 102 with a sealant 500 pre-applied to the fastener 102, according to an embodiment of the present disclosure. Compared to the sealant 112, which may be wrapped around the fastener 102, the sealant 500 may be pre-applied to the fastener 102 via dipping the fastener 102 in the sealant 500, spraying the fastener 102 with the sealant 500, etc. In these embodiments, the sealant 500 may be liquid sealant, aerosolized sealant, microspheres, etc. In an embodiment, the sealant 500 may be applied along threads 502 of the fastener 102.

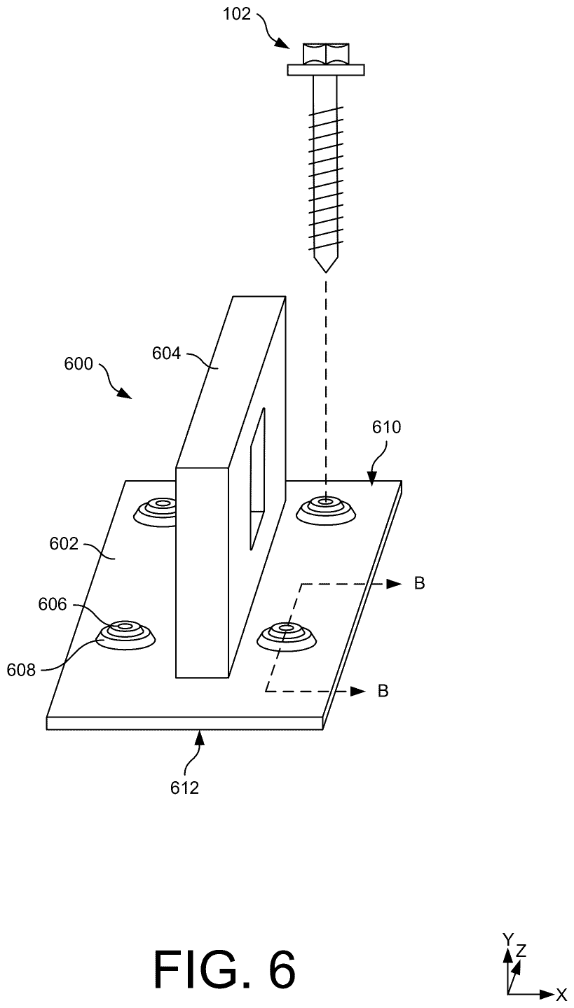

FIG. 6 illustrates an example bracket 600 that may be used to mount solar panel modules to a surface, such as the surface 200, according to an embodiment of the present disclosure. Similar to the bracket 100, the bracket 600 may include a base 602 and a stanchion 604 that extends from the base 602. In addition, the base 602 may include apertures 606 through which the fasteners 102 are disposed for securing the bracket 600 to the surface 200.

The base 602 may include bowls 608 (individually “bowl 608”). The bowls 608 may represent raised portions, cups, platforms, pop-ups, etc. As will be shown and explained herein, the bowls 608 may be configured to transition from a first position, state, etc., as shown in FIG. 6, to a second position, state, etc. The bowls 608 may be formed in the base 602 and may be deformable, such as being transitionable, moveable, etc., between the first position and the second position. In an embodiment, applying a predetermined amount of force to the bowls 608 may cause the bowls 608 to transition from the first position to the second position. Moreover, the apertures 606 may be formed through the bowls 608.

As shown in FIG. 6, the bowls 608 may be disposed above a top 610 of the base 602. The bowls 608 may be open along a bottom 612 of the base 602, opposite the top 610. Sealant may be disposed within the bowls 608, such as along the bottom 612. The bowls 608 may represent raised portions, bosses, bumps, platforms, etc. The bowls 608 may be semi-spherical, conical, etc. In an embodiment, the bracket 600 may include four of the bowls 608 with the apertures 606, respectively.

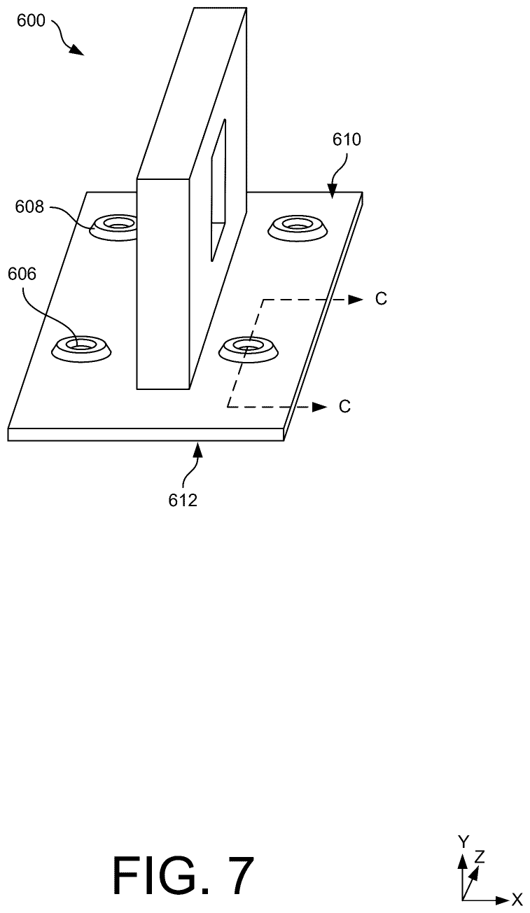

FIG. 7 illustrates the bracket 600, showing the bowls 608 in the second position, according to an embodiment of the present disclosure. For example, from the first position of the bowls 608, as shown in FIG. 6, the bowls 608 may be pushed downwards, in a direction from the top 610 to the bottom 612. In an embodiment, the bowls 608 may pop, snap, etc., from the first position to the second position.

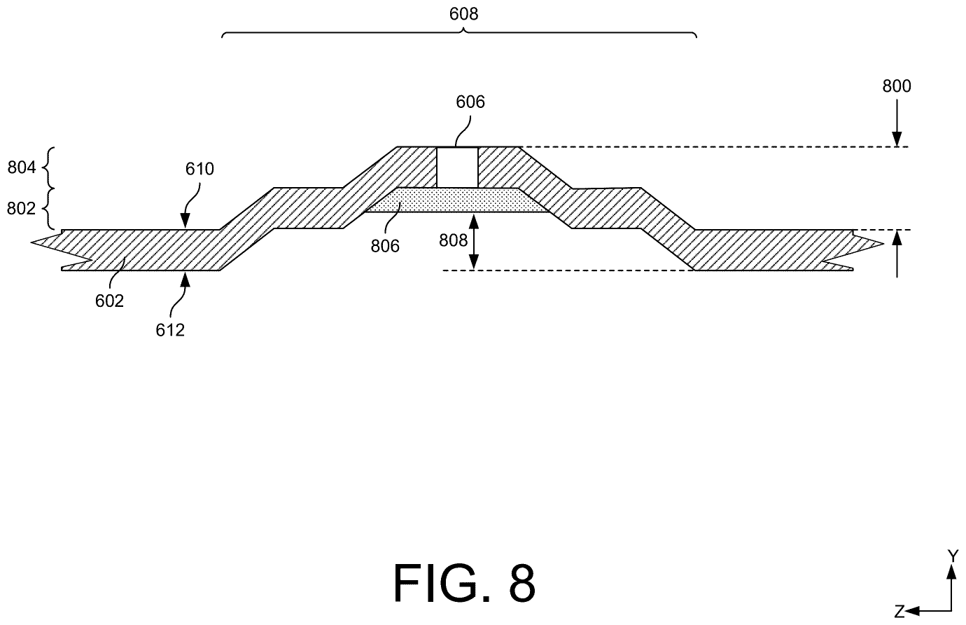

FIG. 8 illustrates a detailed view of one of the bowls 608, taken along line B-B of FIG. 6, according to an embodiment of the present disclosure. In FIG. 8, the bowl 608 is shown in the first position in which the bowl 608 extends above the top 610 of the base 602. In an embodiment, the bowl 608 may extend by a distance 800 above the top 610. The bowl 608 may include a first portion 802 and a second portion 804. The first portion 802 and the second portion 804 may represent different shelves, steps, etc., of the bowl 608. In an embodiment, the first portion 802 and the second portion 804 may include the same height (e.g., in the Y-direction), or may include a different height.

A sealant 806 is shown disposed within the bowl 608 (e.g., a cavity thereof). The sealant 806 may be similar to the sealant 112 as described above. For example, the sealant 806 may include an adhesive strip of butyl. As shown, the sealant 806 may be disposed within the second portion 804 of the bowl 608. The second portion 804 may also include, or define, the aperture 606.

The bowl 608 is open along the bottom 612 such that the sealant 806 is capable of being brought into contact with the surface 200 as the bowl 608 transitions to the second position. However, initially, in the first position of the bowl 608, a gap distance 808 may be disposed between the sealant 806 and the bottom 612. This gap distance 808 may prevent an inadvertent adhesion between the sealant 806 and the surface 200. In an embodiment, a release paper may be disposed over the sealant 806.

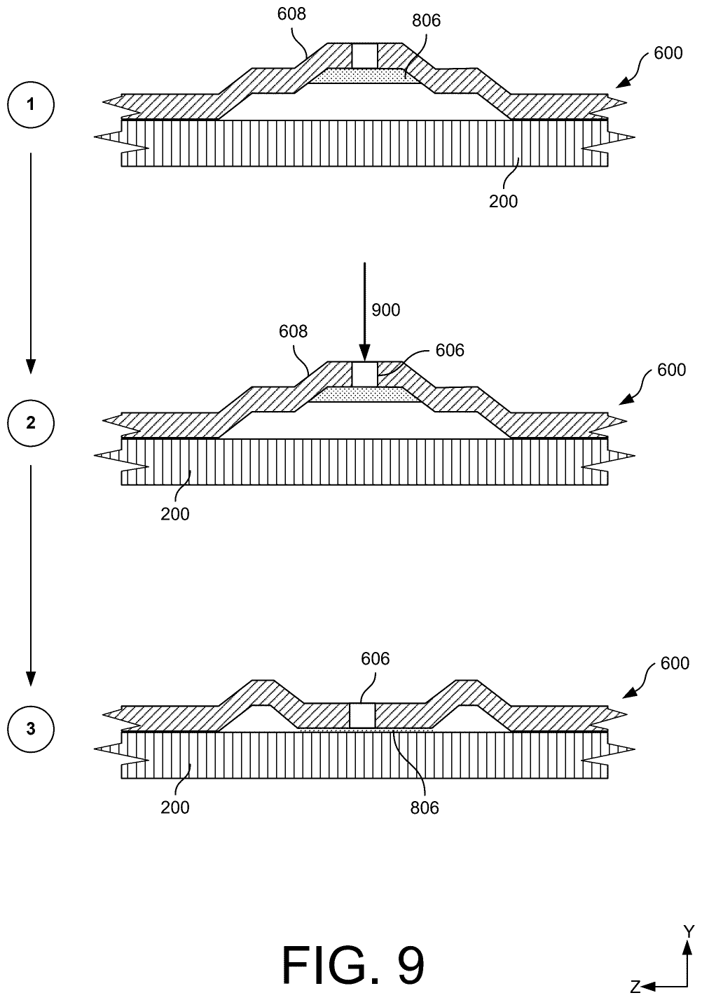

To transition the bowl 608 to the second position, a force may be applied to the top 610, at a location corresponding to the second portion 804. Application of the force results in the bowl 608 transitioning from the first position to the second position. In an embodiment, the force may be applied manually via an installer, via a tool (e.g., hammer), or via the fastener 102 as the fastener 102 is driven into the surface 200 and against the bowl 608. More particularly, and as will be discussed in FIG. 9, the sealant 806 may contact the surface 200 via movement by the gap distance 808 towards the surface 200. During this, the first portion 802 and/or the second portion 804 may at least partially collapse.

The bracket 600 may be made of sheet metal, for example, to permit the bowls 608 to transition from the first position to the second position. However, plastic as well may permit the bowls 608 to snap, pop, etc., between the first position and the second position. The bowl 608, when moved to the second position, may provide a biasing force against the surface 200 to urge the sealant 806 against the surface 200.

FIG. 9 illustrates an example sequence to install the bracket 600 to the surface 200, and an example transitioning of the bowls 608 from the first position to the second position, according to an embodiment of the present disclosure. FIG. 8 illustrates cross-sectional views of the bracket 600 taken along line B-B and line C-C of FIGS. 6 and 7, respectively.

At “1” in FIG. 9, the bracket 600 may be disposed on the surface 200. For example, the bottom 612 may be disposed against the surface 200. The bowl 608 is shown in the first position in which the bowl 608 extends above the top 610 of the base 602. Here, the sealant 806 is disposed within the bowl 608 and is spaced apart from the surface 200 by the gap distance 808. In an embodiment, the bracket 600 may be aligned with a certain location on the surface 200, and thereafter, the bowls 608 may be moved from the first position to the second position. However, by preventing the sealant 806 from contacting the surface 200, the bracket 600 may be moveable across the surface 200 without the sealant 806 adhering, or becoming adhered, to the surface 200.

At “2” in FIG. 9, a force 900 may be applied to the top 610, at a location corresponding to the bowl 608. In an embodiment, the force 900 may be applied adjacent to the aperture 606, and/or the second portion 804 of the bowl 608. Application of the force 900 results in the bowl 608 transitioning from the first position to the second position (as shown at “3” in FIG. 9). More particularly, application of the force 900 may cause the second portion 804 to collapse in a direction towards the surface 200. In an embodiment, the force 900 may be applied manually via an installer, via a tool (e.g., hammer), or via the fastener 102 as the fastener 102 is driven into the surface 200 and against the bowl 608. For example, the fastener 102 may be disposed within the aperture 606, and as the fastener 102 is driven into the surface 200, a head of the fastener 102 may urge against the bowl 608 to move the bowl 608 to the second position.

At “3” in FIG. 9, application of the force 900 causes the bowl 608 to move to the second position. The force 900 may be in a direction from the top 610 to the bottom 612. In the second position, the sealant 806 comes into contact with the surface 200. The fastener 102 may be disposed through the aperture 606 and into the surface 200. As the fastener 102 is disposed through the aperture 606, the fastener 102 passes through the sealant 806 and into the surface 200. The sealant 806 is drawn into the surface 200, or a penetration in the surface 200 formed by the fastener 102. In addition, the sealant 880600 locally seals around the penetration formed in the surface 200.

Although FIG. 9 illustrates a certain embodiment of the bracket 600 after installation, other variations are envisioned. For example, after moving the bowls 608 to the second position, the top 610 may have dimples, bulges, protrusions, buckles, etc. These dimples, bulges, protrusions, buckles, etc., may be formed or induced into the top 610 as the bowls 608 are urged to the second position.

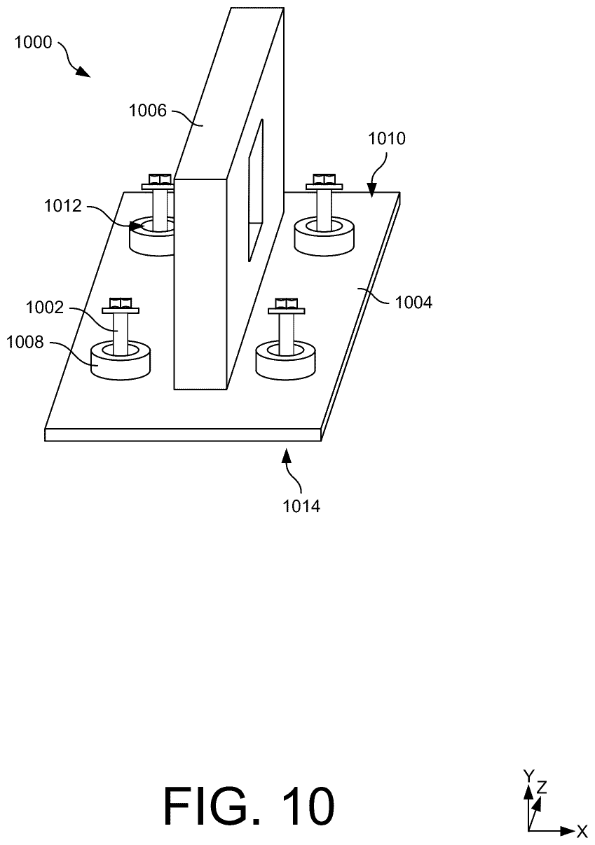

FIG. 10 illustrates an example bracket 1000 with fasteners 1002 (or individually “fastener 1002”) that are pre-installed on the bracket 1000, according to an embodiment of the present disclosure. The bracket 1000 may be similar to the bracket 100 as discussed above. For example, the bracket 1000 may include a base 1004 and a stanchion 1006 extending from the base 1004 for attaching to one or more solar panel modules, whether directly or indirectly.

The base 1004 defines one or more raised portions 1008, which may represent pillars, bosses, columns, platforms, etc., extending above a top 1010 of the base 1004 and/or which are formed on the top 1010 of the base 1004. The raised portions 1008 may define a cavity 1012 in which the fasteners 1002 are at least partially disposed. As will be explained herein, the cavity 1012 may be at least partially filled with a sealant. The sealant may help retain the fasteners 1002 within the raised portions 1008 (or the bracket 1000) and/or an orientation of the fasteners 1002. For example, the sealant may retain the fasteners 1002 in an upright position, such as shown in FIG. 10. A bottom 1014 of the base 1004, as will be explained herein, may define apertures through which the fasteners 1002 are disposed for being secured into the surface 200 (e.g., during a tightening of the fasteners 1002). The sealant is drawn into the surface 200 to create a seal between the bracket 1000, the fasteners 1002, and the surface 200 to prevent an ingress of liquid. That is, as similarly discussed herein, a penetration formed in the surface 200 via the fastener 1002 may be sealed with the sealant.

In an embodiment, the fastener 1002 may act as a plunger to urge the sealant out of the raised portions 1008, or the cavity 1012, to force the sealant into and/or against the surface 200. For example, when the fastener 1002 is tightened, a head of the fastener 1002 may be disposed internal to the cavity 1012. In an embodiment, the head of the fastener 1002 may contact the sealant, with the cavity 1012, and urge (e.g., squeeze, force, etc.), the sealant into the penetrations, or at least partially out of the cavity 1012, to form a seal between the bracket 1000 and the surface 200. As such, a size of the cavity 1012 may be based on a size of the fastener 1002, or vice versa.

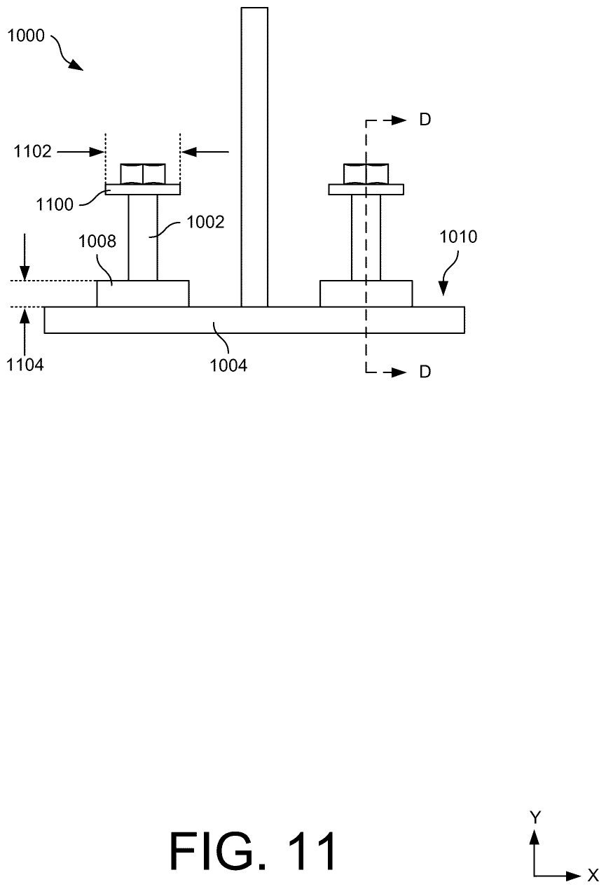

FIG. 11 illustrates a side view of the bracket 1000 and the fasteners 1002, according to an embodiment of the present disclosure. As introduced above, the fasteners 1002 may be at least partially disposed in the cavity 1012 formed by the raised portions 1008. The cavity 1012 is at least partially filled with sealant. The disposition of the fastener 1002 within the cavity 1012 may secure the fasteners 1002 to the bracket 1000. Therein, as an assembly (i.e., with the fasteners 1002 attached to the bracket 1000, via the sealant), the assembly may be transported to the surface 200 for installation. This may reduce the amount of time that an installer spends on the surface 200 installing the bracket 1000. That is, given that the fasteners 1002 are already installed on the bracket 1000, the installer may avoid having to individually grasp the fasteners 1002 (i.e., one by one), place them through the apertures in the bracket 1000, and then secure the bracket 1000 to the surface 200.

A flange 1100 of the fastener 1002, which may be a washer (e.g., EPDM, stainless steel) or a flange of the fastener 1002 (e.g., flanged head), may be configured to be disposed with the cavity 1012 during tightening of the fastener 1002 into the surface 200. For example, the flange 1100 may include a cross-sectional dimension 1102 that is smaller than a cross-sectional dimension of the cavity 1012. The raised portions 1008 may extend above the top 1010 of the base 1004 by a distance 1104. The distance 1104 may accommodate a suitable amount of the sealant disposed within the cavity 1012. Moreover, the distance 1104 may permit a sufficient amount of sealant to be disposed within the cavity 1012, such that the sealant maintains an orientation of the fastener 1002 within the cavity (i.e., once disposed into the sealant).

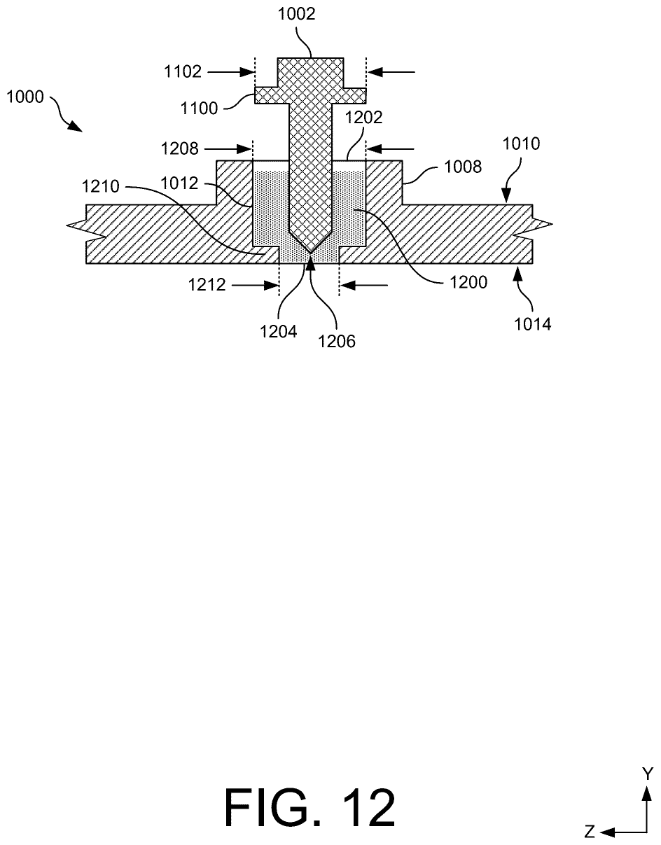

FIG. 12 illustrates a cross-sectional view of the bracket 1000 and the fastener 1002 being pre-installed on the bracket 1000, taken along line D-D of FIG. 11, according to an embodiment of the present disclosure. The raised portions 1008 define the cavity 1012 in which a sealant 1200 is at least partially disposed. The sealant 1200 may be placed, injected into, or otherwise disposed in the cavity 1012. The cavity 1012 includes an aperture 1202 located along a top of the cavity 1012, and an aperture 1204 located along the bottom of the cavity 1012 (e.g., the bottom 1014 of the base 1004). The fastener 1002 may be insertable into the cavity 1012 via the aperture 1202, and may be tightened into the surface 200 via the aperture 1204.

The fastener 1002 may include a tip 1206 that is at least partially disposed within the sealant 1200. The sealant 1200 may also extend along a portion of a length of the fastener 1002. As introduced above, disposing the fastener 1002 at least partially into the sealant 1200 attaches the fastener 1002 to the bracket 1000. For example, the tip 1206 may be urged into, pushed into, etc., the sealant 1200. In doing so, the fastener 1002 becomes lodged within the sealant 1200 to attach the fastener 1002 to the bracket 1000. With the fastener 1002 pre-installed on the bracket 1000, the bracket 1000 may be transported to the surface 200 for installation. Alternatively, the fasteners 1002 may be attached to the bracket 1000 on the surface 200. Regardless of the specific embodiment, pre-installing the fasteners 1002 on the bracket 1000 may reduce installation times and increase the ease of installation.

As the fastener 1002 is tightened into the surface 200, the fastener 1002 may be drawn into the cavity 1012. The flange 1100 has the cross-sectional dimension 1102, and the aperture 1202 has a cross-sectional dimension 1208 that accommodates the cross-sectional dimension 1102. Therefore, the fastener 1002 (or the head of the fastener 1002) may be disposable within the cavity 1012. As the flange 1100 enters the cavity 1012, the flange 1100 may act on the sealant 1200 (e.g., press, push, etc.) to urge the sealant 1200 out of the cavity 1012. Given that the fastener 1002 is engaged with the sealant 1200, the sealant 1200 may be drawn into the surface 200 as the fastener 1002 is disposed into the surface 200.

The aperture 1204 may have a cross-sectional dimension 1208 that is smaller than a cross-sectional dimension 1212 of the aperture 1204. The flange 1100 may bottom out in the cavity 1012 via an engagement with a shelf 1210 (e.g., flange, lip, overhang, etc.). This engagement retains the fastener 1002 within the cavity 1012.

In an embodiment, the cavity 1012 may be entirely filled with the sealant 1200. Alternatively, the sealant 1200 may be at least partially filled with the sealant 1200. In an embodiment, release paper may be disposed along the bottom 1014, adjacent to the aperture 1204, and/or along the top 1010, adjacent to the aperture 1202, to prevent inadvertent adhesion of the sealant 1200.

Although a certain size, shape, etc., of the raised portion 1008 and/or the cavity 1012 is shown, other variations are envisioned. For example, the cavity 1012 may be differently shaped, and/or the cavity 1012 may include a different depth (e.g., in the Y-direction) than shown. Still, the raised portions 1008 may extend from the top 1010 of the base 1004, or be disposed above the top 1010, differently than shown. In an embodiment, the raised portion 1008 may be omitted, but instead, the cavity 1012 may be formed in the base 1004. In such instances, the base 1004 may include a sufficient thickness (e.g., in the Y-direction) to accommodate the sealant 1200.

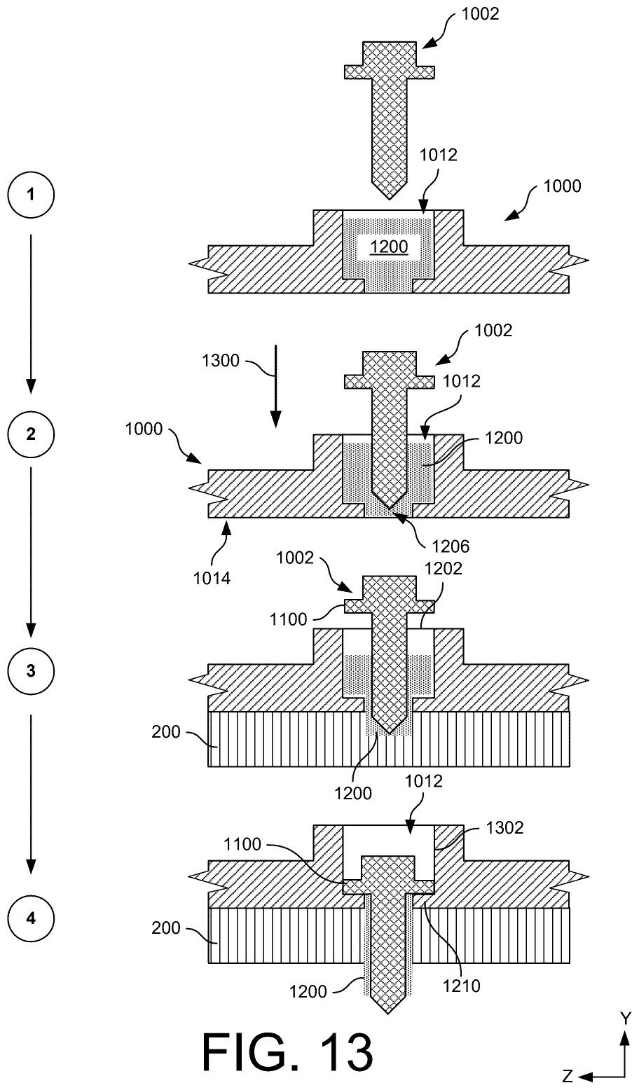

FIG. 13 illustrates an example sequence to attach the bracket 1000 to the surface 200, according to an embodiment of the present disclosure. The views illustrated in FIG. 13 are cross-sectional views of the bracket 1000, taken along line D-D of FIG. 11.

At “1” in FIG. 13, the fastener 1002 is shown being uninstalled on the bracket 1000. For example, the fastener 1002 may not be disposed in the cavity 1012. The cavity 1012 is shown being at least partially filled with the sealant 1200. The sealant 1200 may be injected into the cavity 1012, placed in the cavity, etc.

At “2” in FIG. 13, the fastener 1002 may be installed on the bracket 1000. For example, the tip 1206 of the fastener 1002 may be pushed in a direction 1300 to advance the fastener 1002 at least partially into the sealant 1200. The fastener 1002 may be pushed into the sealant 1200 via any suitable depth, however, in an embodiment, the tip 1206 may not be pushed past the bottom 1014 of the base 1004. The disposition of the fastener 1002 in the sealant 1200 secures the fastener 1002 to the bracket 1000. In other words, an engagement between the fastener 1002 and the sealant 1200 retains the fastener 1002 within the cavity 1012. In an embodiment, an engagement between the fastener 1002 and the sealant 1200 may maintain an upright position of the fastener 1002 to assist the installer during installation. With the fastener 1002 installed on the bracket 1000, the bracket 1000 (with the fastener 1002) may be disposed on the surface 200.

For example, at “3” in FIG. 13, the fastener 1002 is shown being driven into the surface 200. As the fastener 1002 is driven into the surface 200, an engagement between the fastener 1002 and the sealant 1200 has the effect of pulling, advancing, or drawing the sealant 1200 into penetrations formed in the surface 200 via the fastener 1002. This helps to seal the penetration and the bracket 1000 to the surface 200. Moreover, as shown at “3” in FIG. 13, as the fastener 1002 is secured into the surface 200, the flange 1100 draws near the aperture 1202.

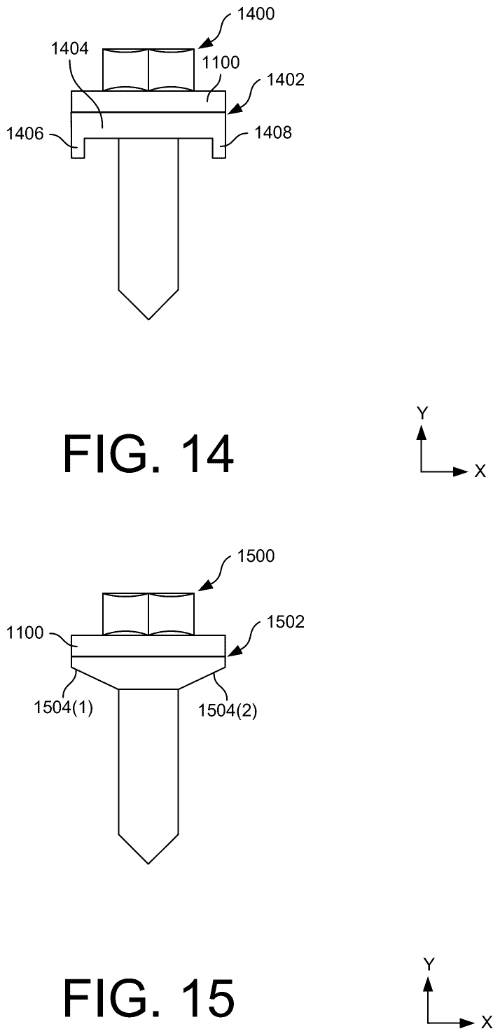

At “4” in FIG. 13, the fastener 1002 is shown being fully disposed in the surface 200. As the fastener 1002 is further advanced into the surface 200, from “3” to “4” in FIG. 13, the flange 1100 presses against the sealant 1200 and urges the sealant 1200 out of the cavity 1012. This urging may cause the sealant 1200 to be forced into the penetrations formed in the surface 200, and/or occupy a space around the penetration, between the bracket 1000 and the surface 200. The flange 1100 may engage with sidewalls 1302 of the cavity 1012 to act as a plunger to squeeze or force the sealant 1200 into the penetrations and/or out the cavity 1012. As also shown at “4” in FIG. 14, the flange 1100 may come to rest on the shelf 1210. At this point, the fastener 1002 may no longer be advanced into the surface 200.

FIG. 14 illustrates an example fastener 1400 and an example plunger 1402 usable with the bracket 1000, according to an embodiment of the present disclosure. In an embodiment, the fastener 1400 and the plunger 1402 may be used in lieu of the fastener 1002. In an embodiment, the fastener 1400 and the fastener 1002 may be the same, but the plunger 1402 may be used in addition to the fastener 1002.

The plunger 1402 may serve to urge or force the sealant 1200 out of the cavity 1012, similar to the function of the flange 1100. In an embodiment, the fastener 1400 may include the flange 1100, or the flange 1100 may be omitted. In an embodiment, the plunger 1402 may include an aperture through which the fastener 1400 is at least partially disposed. The plunger 1402 may include a base 1404 that defines the aperture, a first arm 1406, and a second arm 1408. The first arm 1406 and the second arm 1408 extend transversely from the base 1404. The first arm 1406 and the second arm 1408 may help to retain the sealant 1200 within the cavity 1012 and the sealant 1200 and/or assist in urging the sealant 1200 out of the cavity 1012 while tightening the fastener 1002 into the surface 200. The first arm 1406 and the second arm 1408 may engage with the shelf 1210 when the fastener 1002 is fully secured into the surface 200. The plunger 1402 may be manufactured from plastic, metal, rubber, etc.

FIG. 15 illustrates an example fastener 1500 and an example plunger 1502 usable with the bracket 1000, according to an embodiment of the present disclosure. In an embodiment, the fastener 1500 and the plunger 1502 may be used in lieu of the fastener 1002. In an embodiment, the fastener 1500 may include the flange 1100, or the flange 1100 may be omitted. In an embodiment, the fastener 1500 and the fastener 1002 may be the same, but the plunger 1502 may be used in addition to the fastener 1002.

The plunger 1502 may serve to urge or force the sealant 1200 out of the cavity 1012, similar to the function of the flange 1100. In an embodiment, the plunger 1502 may include an aperture through which the fastener 1500 is at least partially disposed. The plunger 1502 may include conically shaped or tapered sidewalls 1504(1) and 1504(2). The sidewalls 1504(1) and 1504(2) may help retain the sealant 1200 within the cavity 1012 and/or assist in urging the sealant 1200 out of the cavity 1012 during tightening of the fastener 1002 into the surface 200. The plunger 1502 may be manufactured from plastic, metal, rubber, etc.

FIG. 16 illustrates an example environment in which collated fasteners 1600 are used to secure brackets 1602 to a surface 1604, according to an embodiment of the present disclosure. The brackets 1602 may include apertures through which individual ones of the collated fasteners 1600 are disposed for securing the brackets 1602 to the surface 1604. The collated fasteners 1600 may include a plurality of fasteners 1606 (or individually “fastener 1606”) that are disposed or secured to a strip 1608 that is fed through a screw gun 1610, for example. The strip 1608 connects the fasteners 1606 together to form the collated fasteners 1600 or a strip of the collated fasteners 1600. In doing so, the collated fasteners 1600 may be fed through the screw gun 1610. For example, the strip 1608 may be fed through the screw gun 1610 to reduce the amount of time required to secure the brackets 1602 to the surface 1604.

A sealant may be pre-applied to the collated fasteners 1600 to create a seal against the surface 1604, around the collated fasteners 1600, around the brackets 1602, etc., as the collated fasteners 1600 are secured into the surface 1604. In an embodiment, the collated fasteners 1600 are at least partially disposed through a container 1612 that, as will be explained herein, contains the sealant. The sealant may be disposed within the container 1612 to prevent the sealant, before use, adhering to other surfaces, becoming contaminated with debris, etc. However, as the collated fasteners 1600 are secured into the surface 1604 and advanced through the container 1612, the sealant may become engaged with the collated fasteners 1600 and disposed within a hole (e.g., penetration) in the surface 1604 created by the fasteners 1606. In doing so, the sealant forms a watertight seal around the fasteners 1606, the brackets 1602, and/or the surface 1604 to prevent an ingress of water into or through the surface 1604. In an embodiment, the collated fasteners 1600, or the fasteners 1606, the sealant, the strip 1608, the containers 1612, etc., may be referred to as an assembly, a system, etc.

Although not shown, in an embodiment, the brackets 1602 may support solar panel modules above the surface 1604. The brackets 1602 may be similar to the brackets 100 as discussed hereinabove. The solar panel modules may attach to the brackets 1602 (e.g., via fasteners, mounts, etc.). However, the collated fasteners 1600 may be used to secure other mounts, clamps, etc., to the surface 1604, and/or the collated fasteners 1600 may be used in applications other than mounting solar panel modules, whether on the surface 1604 or other surfaces. The surface 1604 into which the collated fasteners 1600 are secured may represent any suitable surface, including different layers or materials. For example, the surface 1604 may represent a composite shingle roof. The surface 1604 may be similar to the surface 200, or vice versa.

In an embodiment, the screw gun 1610 includes a feed mechanism 1614 that is used to feed, orient, etc., the collated fasteners 1600 through the screw gun 1610 such that a driver (e.g., hex, Phillips, etc.) secured within a chuck of the screw gun 1610 may drive the collated fasteners 1600 into the surface 1604. The screw gun 1610 may individually drive the fasteners 1606 of the collated fasteners 1600 into the surface 1604. The feed mechanism 1614 may pull, drive, etc., the strip 1608 to feed the collated fasteners 1600 through the screw gun 1610 as the collated fasteners 1600 are disposed into the surface 1604.

Although a particular type of the fastener 1606 is shown, other types of fasteners are envisioned, such as hex, flanged hex, button, socket head, flanged socket head, etc. The fastener 1606 may also be similar to the fastener 102 discussed hereinabove.

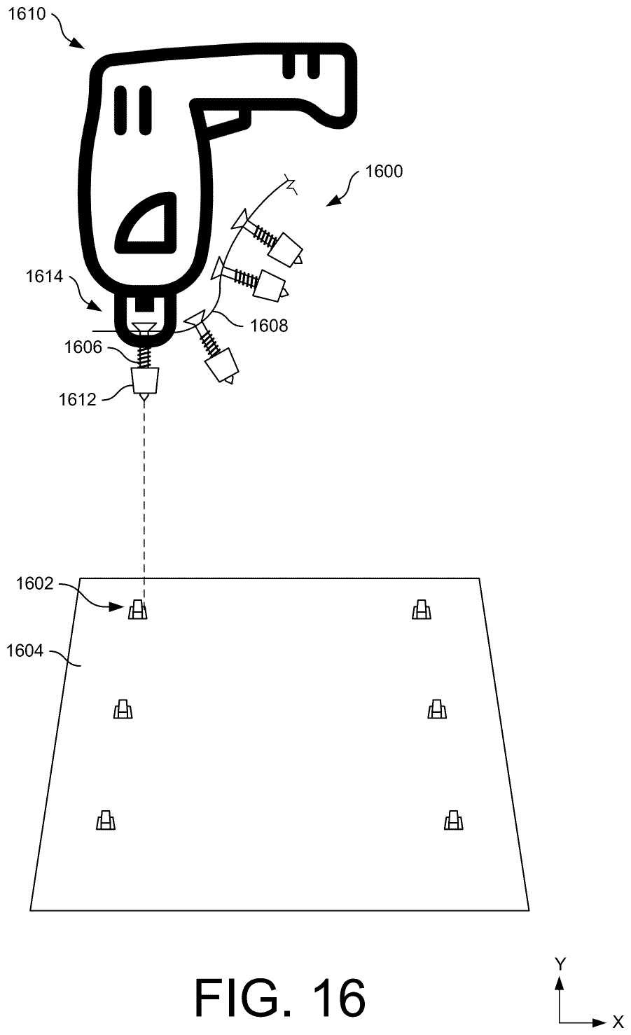

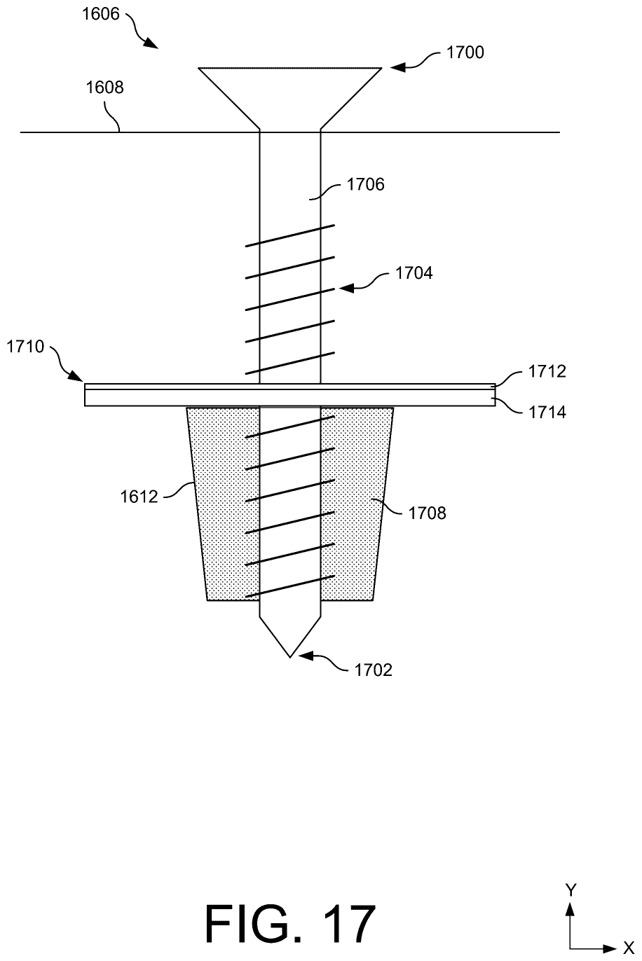

FIG. 17 illustrates a fastener 1606 of the collated fasteners 1600, according to an embodiment of the present disclosure. The fastener 1606 may include a head 1700 (e.g., first end) and a tip 1702 (e.g., second end) spaced apart from the head 1700. Threads 1704 may extend along a body 1706 of the fastener 1606, between the head 1700 and the tip 1702. In an embodiment, the threads 1704 may be disposed along any portion of the body 1706. Moreover, the body 1706 may include different types of threads.

As shown, the fastener 1606 may secure to the strip 1608 proximate to the head 1700, to form the collated fasteners 1600 that are fed into the screw gun 1610 via the feed mechanism 1614. However, the strip 1608 may be secured to the fastener 1606 at any location along the body 1706, proximate to the tip 1702, etc. The container 1612 may be disposed along a portion of the body 1706. In an embodiment, the container 1612 may be disposed proximate to the tip 1702. Moreover, in an embodiment, the tip 1702 may be disposed external to the container 1612.

The container 1612 in FIG. 17 is shown as transparent to illustrate a sealant 1708 disposed within the container 1612. The container 1612 may be at least partially filled with the sealant 1708, which may be in solid, liquid, etc., form. As the fastener 1606 is driven into the surface 1604, through the container 1612, the threads 1704 engage with the sealant 1708 to dispose (e.g., draw) the sealant 1708 into a hole of the surface 1604 created by the fastener 1606. For example, the sealant 1708 may become entangled, engaged, embedded, etc., with the threads 1704 as the fastener 1606 is rotated (e.g., drive) into the surface 1604. As the fastener 1606 is advanced into the surface 1604, the sealant 1708 may be pulled out of the container 1612 and into the hole in the surface 1604.

A washer 1710 may be disposed about the fastener 1606. As shown, the washer 1710 may be disposed between the strip 1608 and the container 1612. However, in an embodiment, the washer 1710 may be disposed vertically above the strip 1608 (e.g., in the Y-direction). The washer 1710 may be attached or unattached to the container 1612. As will be explained herein, the washer 1710 may engage with the container 1612 (e.g., a top surface) to assist in forcing the sealant 1708 out of the container 1612 and/or sealing the bracket 1602 against the surface 1604, sealing the fastener 1606 against the bracket 1602, etc. In an embodiment, the washer 1710 may include a first portion 1712 made of a first material (e.g., metal) and a second portion 1714 made of a second material (e.g., EPDM). As shown, the second portion 1714 may be disposed vertically below the first portion 1712.

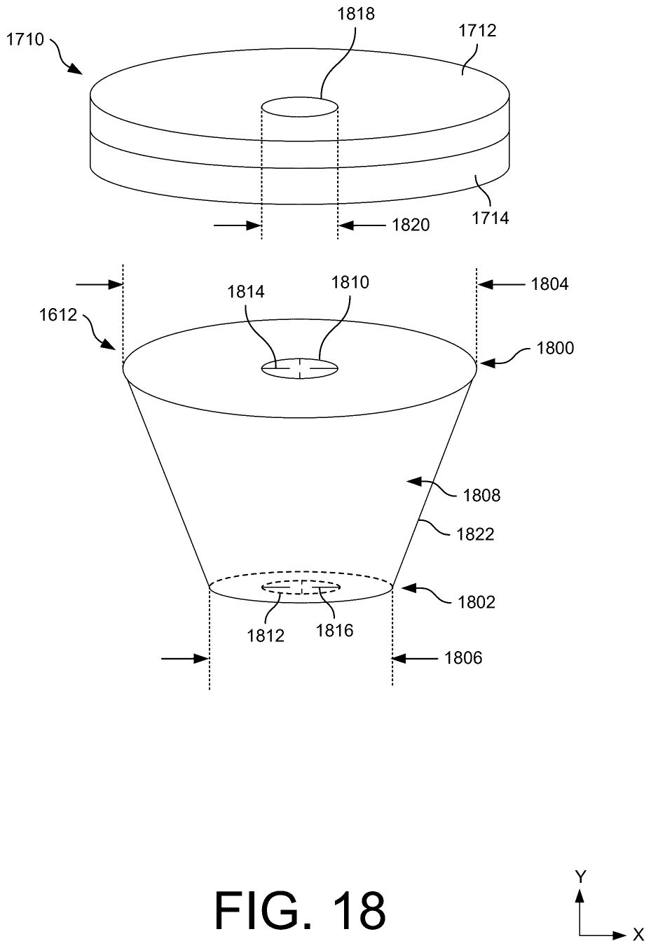

FIG. 18 illustrates details of the container 1612 and the washer 1710, according to an embodiment of the present disclosure. The container 1612 may include a first end 1800 and a second end 1802 spaced apart from the first end 1800 (e.g., in the Y-direction). As shown, the container 1612 may include a conical shape, however, other shapes are envisioned (e.g., cylindrical, hexagonal, etc.). The first end 1800 may have a first cross-sectional dimension 1804 (e.g., in the X-direction) that is greater than a second cross-sectional dimension 1806 at the second end 1802. The shape of the container 1612 may assist in funneling the sealant 1708 out of the container 1612 and into the surface 1604, for example. This is also accomplished via an engagement between the sealant 1708 with the fastener 1606 to draw the sealant 1708 out of the container 1612. The container 1612 includes a cavity 1808 in which the sealant 1708 is disposed. In FIG. 18, the sealant 1708 is shown removed from the cavity 1808.

As introduced above, the fasteners 1606 are configured to be disposed through the container 1612. For example, the tip 1702 of the fastener 1606 may extend through the container 1612. In an embodiment, the first end 1800 of the container 1612 may include a first opening 1810 and the second end 1802 of the container 1612 may include a second opening 1812. The tip 1702 of the fastener 1606 may be disposed through the first opening 1810, through the container 1612, and out the second opening 1812. A length of the body 1706 or a portion of the body 1706 may be disposed within the cavity 1808. In an embodiment, the container 1612 may include tabs 1814 that are disposed within the first opening 1810 and/or tabs 1816 that are disposed within the second opening 1812 to secure the container 1612 to the fastener 1606. For example, the tabs 1814 and/or the tabs 1816 may engage with an exterior surface, the threads 1704, etc., of the fastener 1606. In an embodiment, rather than the second end 1802 including the second opening 1812, the second end 1802 may be open (e.g., open-ended) to allow the sealant 1708 to be drawn out of the container 1612 as the fastener 1606 is disposed into the surface 1604.

The sealant 1708 may be disposed within the cavity 1808 before, after, or while the fastener 1606 is disposed through the container 1612. In instances in which the sealant 1708 is disposed within the container 1612 before the container 1612 is attached to the fastener 1606, the fastener 1606 may be pushed through the sealant 1708 within the container 1612.

Introduced above, the washer 1710 includes the first portion 1712 (e.g., metal) and the second portion 1714 (e.g., EPDM). In an embodiment, the first portion 1712 and the second portion 1714 may be sized similarly or differently (e.g., width in the X-direction, thickness in the Y-direction, etc.). The washer 1710 may form and/or otherwise include a through hole 1818 configured to accept the fastener 1606. The through hole 1818 may extend from a top surface of the washer 1710 to a bottom surface of the washer 1710. In an embodiment, the first opening 1810 may be sized based on an outer diameter of the fastener 1606 such that the washer 1710 is secured to the fastener 1606. For example, a diameter 1820 of the first opening 1810 may be sized smaller than an outer diameter (or gauge) of the fastener 1606. The diameter 1820 may be based at least in part on the gauge of the fastener 1606. In an embodiment, a diameter of the washer 1710 may be sized larger than, smaller than, or equal to the container 1612 (e.g., at the first end 1800 or the second end 1802).

As will be explained herein, the container 1612 may be manufactured from a deformable material, such as plastic. For example, as the fastener 1606 is secured into the surface 1604 the washer 1710 may compress, deform, buckle, etc., the container 1612 against the bracket 1602. The container 1612 may include thinned sidewalls 1822 that are capable of being compressed. Moreover, the material of the container 1612 may prevent the sealant 1708 adhering to the container 1612 such that the sealant 1708 is capable of being drawn out of the container 1612. The container 1612 may also be manufactured from biodegradable materials.

In an embodiment, the sealant 1708 may not be contained within the container 1612, but may be disposed about the fastener 1606. Before being installed, a release paper wrapped around the sealant 1708 may be removed. Alternatively, the fastener 1606 may be installed without removing the release paper from the fastener 1606.

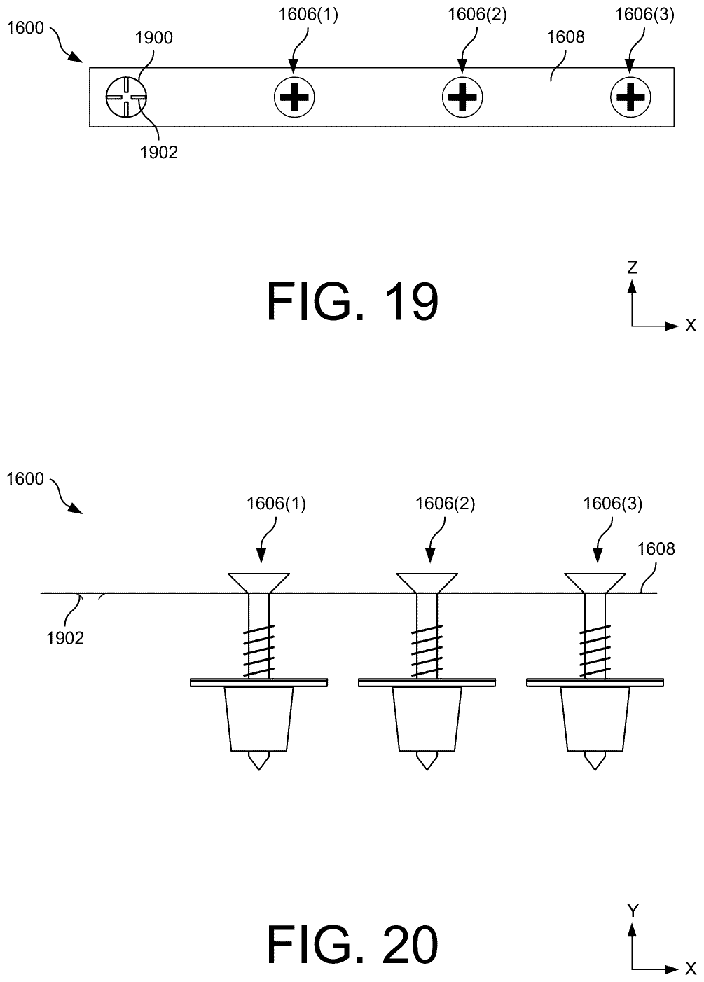

FIG. 19 illustrates a top view of the collated fasteners 1600, according to an embodiment of the present disclosure. More than one of the fasteners 1606 may be connected together via the strip 1608 to form the collated fasteners 1600. For example, in FIG. 19, a first fastener 1606(1), a second fastener 1606(2), and a third fastener 1606(3) are shown connected to the strip 1608. The strip 1608 may include receptacles 1900 into which the fasteners 1606 are disposed. Moreover, tabs 1902 may be disposed internal to the receptacle 1900 to engage the fasteners 1606. An engagement between the tabs 1902 and the fasteners 1606 may secure the fasteners 1606 to, or within, the strip 1608. For example, a previous fastener 1606 may have been disposed within the receptacle 1900, but upon fastening the fastener 1606 into the surface 1604, becomes separated from the strip 1608. In an embodiment, the head 1700 of the fasteners 1606 may slip, puncture, or otherwise advance through the receptacle 1900.

FIG. 20 illustrates a side view of the collated fasteners 1600, according to an embodiment of the present disclosure. As shown in the side view, the tabs 1902 are disposed within the receptacle 1900 and may have been previously engaged with a fastener 1606 residing in the receptacle 1900. The fasteners 1606(1)-(3) may be secured within respective receptacles via an engagement with the tabs 1902.

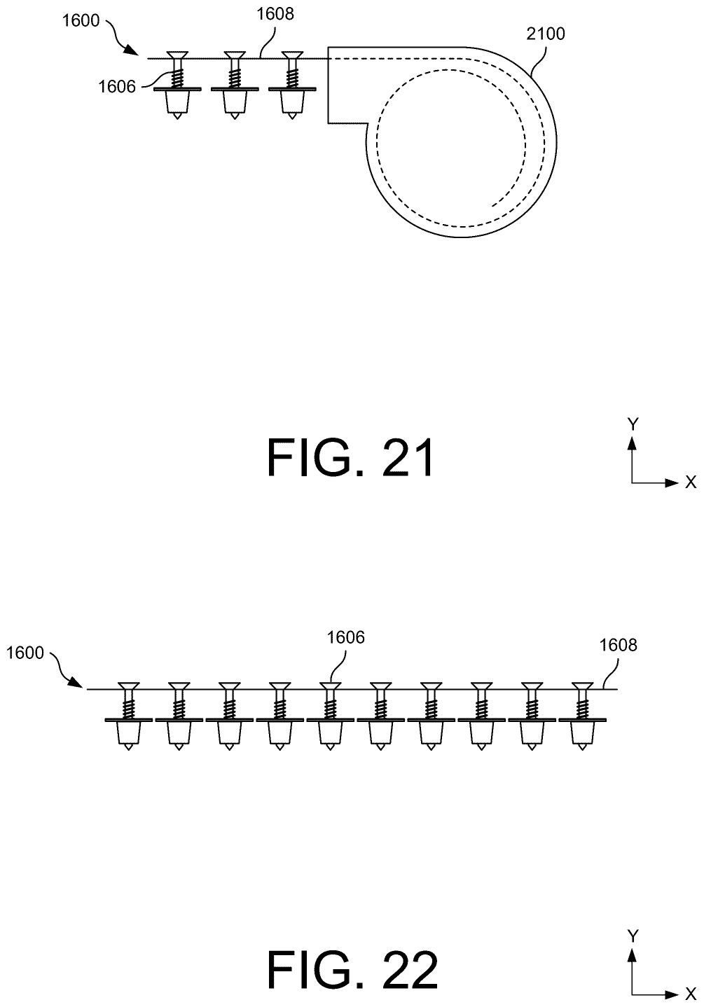

FIG. 21 illustrates the collated fasteners 1600 being disposed within a drum 2100, according to examples of the present disclosure. The collated fasteners 1600 may be connected via the strip 1608, but the collated fasteners 1600 may be wound or coiled within the drum 2100. In an embodiment, the collated fasteners 1600 may be wound about a post, column, axle, etc., within the drum 2100. During installation of the brackets 1602 into the surface 1604, for example, the drum 2100 may be transported to the surface 1604 and the strip 1608 may be fed into the screw gun 1610 to interact with the feed mechanism 1614. As the fasteners 1606 are secured into the surface 1604, the collated fasteners 1600 may be unspooled from the drum 2100. For example, as the feed mechanism 1614 advances the strip 1608, the collated fasteners 1600 may be pulled or unwound from within the drum 2100. The drum 2100 may hold a plurality of the collated fasteners 1600.

The use of the drum 2100 may permit the collated fasteners 1600 to be easily transported, may reduce damage to the collated fasteners 1600 during transport, may reduce the number of items (e.g., tools, supplies, etc.) needing to be transported to the surface 1604 during installation, etc. Moreover, although described as being retained within the drum 2100, the collated fasteners 1600 may be disposed within a magazine, coil, clip, etc., that is fed into the screw gun 1610 and engageable with the feed mechanism 1614. Additionally, although described as being separate from the screw gun 1610, in an embodiment, the drum 2100 may be connected to the screw gun 1610 via clips, buckles, male/female connectors, etc.

FIG. 22 illustrates a side view of the collated fasteners 1600, according to an embodiment of the present disclosure. In FIG. 22, the collated fasteners 1600 is shown including ten of the fasteners 1606. Similar to the previous embodiments, the collated fasteners 1600 may be fed into the screw gun 1610 to permit the fasteners 1606 of the collated fasteners 1600 to be conveniently installed on the surface 1604.

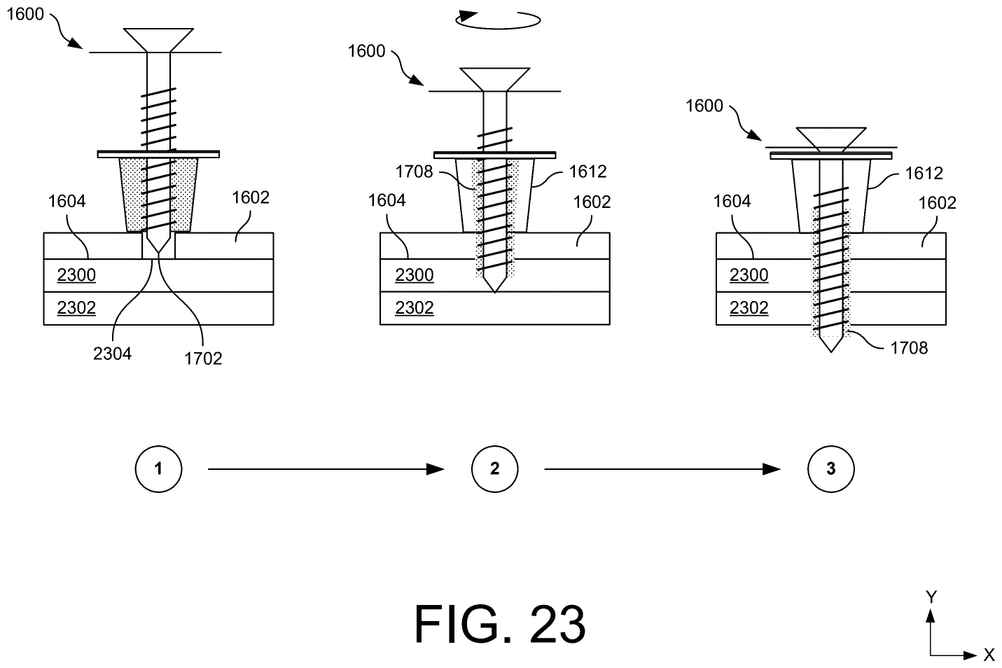

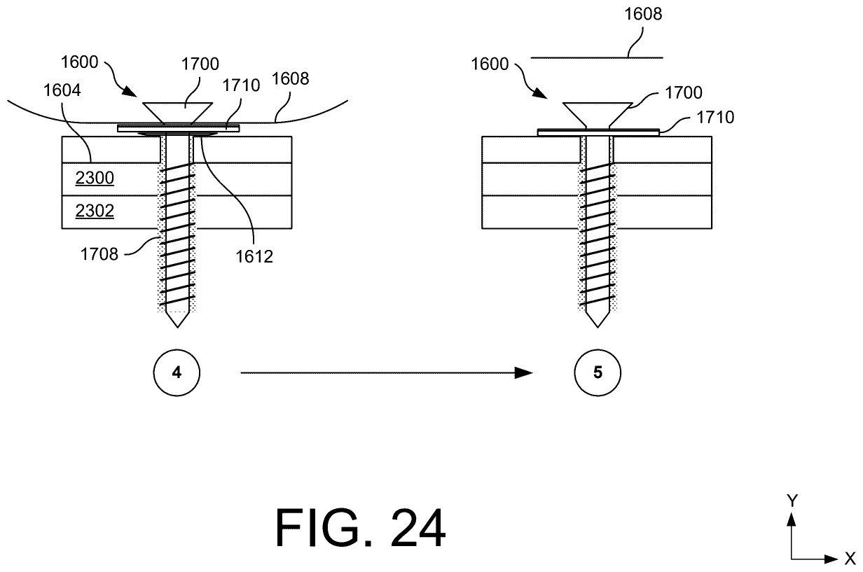

FIGS. 23 and 24 illustrate an example sequence for installing the collated fasteners 1600 into the surface 1604, according to an embodiment of the present disclosure. The surface 1604 may be similar to the surface 200, or vice versa. As introduced above, the surface 1604 may include a plurality of layers, such as composite shingles 2300 and sheathing 2302. Although not shown, the surface 1604 may include tar paper, rafters disposed beneath the sheathing 2302, flashing, etc. The bracket 1602 may be disposed on top of the surface 1604 and include an aperture 2304 through which the collated fastener 1600 is disposed for attaching the bracket 1602 to the surface 1604.

At “1” in FIG. 23, the tip 1702 of the collated fastener 1600 may be disposed adjacent to or within the aperture 2304. Although not shown, the collated fastener 1600 may be engaged with, inserted into, etc., the screw gun 1610 and/or the feed mechanism 1614 for being driven into the surface 1604.

At “2” in FIG. 23, the screw gun 1610 may be used to drive the collated fastener 1600 into the surface 1604. For example, the collated fastener 1600 may be disposed through the aperture 2304 and into the composite shingles 2300. As the collated fastener 1600 is advanced into the surface 1604, the sealant 1708 is drawn into a hole (e.g., penetration) in the surface 1604 created by the collated fastener 1600. In other words, given an adhesion between the sealant 1708 and the collated fastener 1600, as the collated fastener 1600 is driven into the surface 1604, the sealant 1708 may be partially removed from the container 1612. The sealant 1708 may be drawn out of the second end 1802 of the container 1612 through the second opening 1812, for example. In an embodiment, the sealant 1708 may become embedded, entwined, etc., with the threads 1704 of the collated fastener 1600 to draw the sealant 1708 out of the container 1612.

At “3” in FIG. 23, as the collated fastener 1600 is further driven into the surface 1604, such as into the sheathing 2302, the sealant 1708 continues to be drawn out of the container 1612 to seal the hole in the surface 1604.

At “4” in FIG. 24, the container 1612 may be collapsed as the collated fastener 1600 is further driven into the surface 1604. For example, the head 1700 of the collated fastener 1600 may engage with the washer 1710, which in turn, is urged against the first end 1800 of the container 1612. As the collated fastener 1600 is driven into the surface 1604, the washer 1710 may act on the container 1612 to cause the container 1612 to compress, buckle, deform, break and fall away, etc. In an embodiment, during this deformation, any of the sealant 1708 remaining in the container 1612 may be squeezed out and seal around the container 1612, the collated fastener 1600, within the aperture 2304 of the bracket 1602, etc. As such, the container 1612 may become fastened to the surface 1604, between the head 1700 of the collated fastener 1600 and the bracket 1602. As also shown at “4” in FIG. 24, the strip 1608 may bend as the collated fastener 1600 is driven into the surface 1604.

At “5” in FIG. 24, the collated fastener 1600 may be separated from the strip 1608. For example, the head 1700 of the collated fastener 1600 may be advanced through the receptacle 1900 to separate from the strip 1608. In an embodiment, the container 1612 may become immersed, embedded, etc., within the second portion 1714 (i.e., the EPDM) of the washer 1710 to seal around the container 1612 and prevent an ingress of liquid into the surface 1604, or through the aperture 2304. Moreover, as discussed above, the second portion 1714 may assist in sealing the hole created by the collated fastener 1600. The first portion 1712 may assist in compressing against the container 1612 to squeeze the sealant 1708 out of the container 1612 and around the aperture 2304, the bracket 1602, the collated fastener 1600, etc. After the collated fastener 1600 is separate from the strip 1608, the feed mechanism 1614 may advance another of the collated fasteners 1600 on the strip adjacent to the driver of the screw gun 1610.

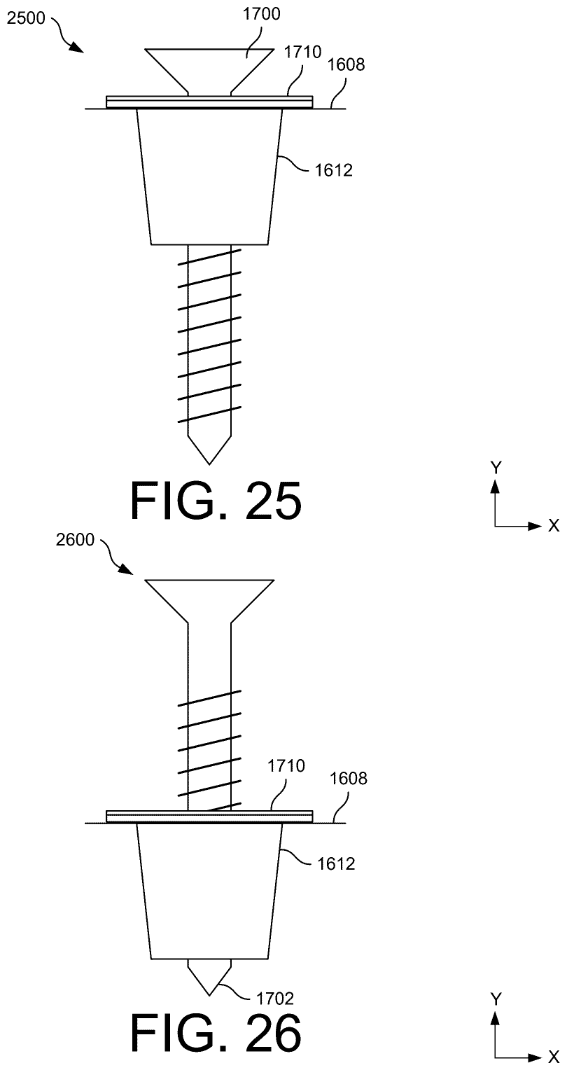

FIGS. 25-30 illustrate different embodiments of collated fasteners, according to an embodiment of the present disclosure. The collated fasteners described in FIGS. 25-30 may be similar to the collated fasteners 1600 as discussed above, but may include a different arrangement of the components. The collated fasteners as described in FIGS. 25-30 may be used with the screw gun 1610, for example, and may be compatible with the feed mechanism 1614 to secure the bracket 1602 into the surface 1604.

FIG. 25 illustrates a collated fastener 2500, whereby the washer 1710 may be disposed above the strip 1608, between the head 1700 and the strip 1608. The container 1612 may also be integrated within the strip 1608. For example, the container 1612 and the strip 1608 may be formed from the same piece of material. Alternatively, the container 1612 may be attached to the strip 1608, such as using adhesives, welding, etc. As also shown, the strip 1608 and the container 1612 may be disposed proximate to the head 1700. When the collated fastener 2500 is disposed into the surface 1604, in an embodiment, the strip 1608 may fracture (e.g., break) to separate the collated fastener 2500 from the strip 1608.

FIG. 26 illustrates a collated fastener 2600, whereby the washer 1710 is disposed vertically above the strip 1608, and the washer 1710, the strip 1608, and the container 1612 are disposed proximate to the tip 1702. That is, compared to the collated fastener 2500, for example, the washer 1710, the strip 1608, and the container 1612 are disposed proximate to the tip 1702. When the collated fastener 2600 is disposed into the surface 1604, in an embodiment, the strip 1608 may fracture (e.g., break) to separate the collated fastener 2500 from the strip 1608.

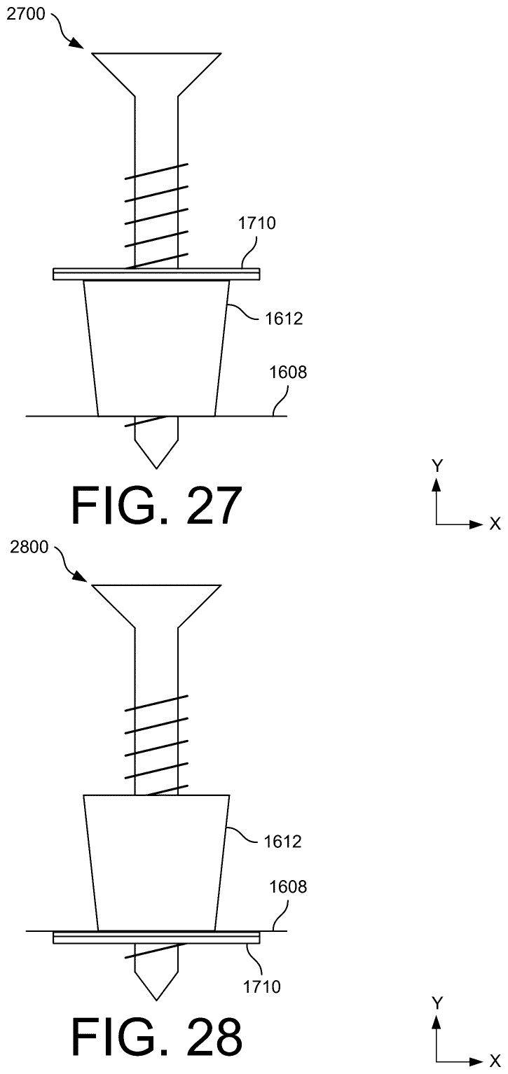

FIG. 27 illustrates a collated fastener 2700, whereby the washer 1710 and the container 1612 are disposed above the strip 1608. During a securement of the collated fastener 1600 into the surface 1604, the sealant 1708 in the container 1612 may pass through the second opening 1812 and the receptacle 1900. When the collated fastener 2700 is disposed into the surface 1604, in an embodiment, the strip 1608 may fracture (e.g., break) to separate the collated fastener 2700 from the strip 1608.

FIG. 28 illustrates a collated fastener 2800, whereby the container 1612 is disposed above the strip 1608, but the washer 1710 is disposed below the strip 1608. When the collated fastener 2800 is disposed into the surface 1604, the head of the collated fastener 1600 may pass through the container 1612 and the strip 1608, thereby separating from the strip 1608. The collated fastener 2800 may then engage the washer 1710 to tighten against the bracket 1602.

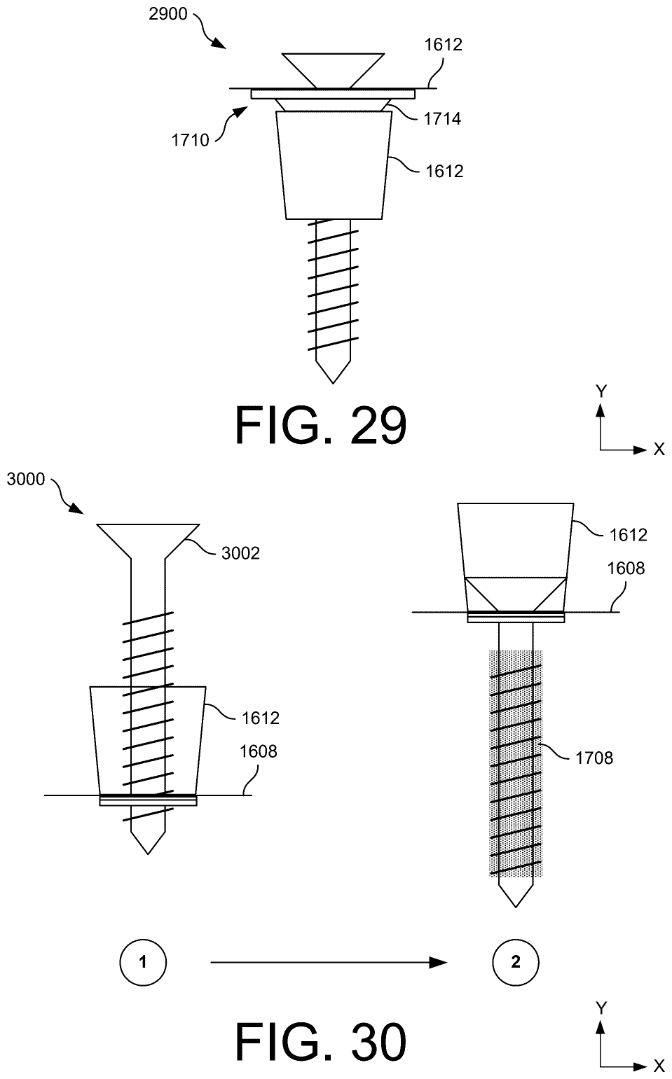

FIG. 29 illustrates a collated fastener 2900, whereby the washer 1710 and the container 1612 are disposed below the strip 1608. In addition, as shown, the second portion 1714 of the washer 1710 may be conically shaped to squeeze, push, etc., the sealant 1708 out of the container 1612. For example, as the washer 1710 is urged against the container 1612, the second portion 1714 of the washer 1710 may have the effect of plunging the sealant 1708 into the hole in the surface 1604 In an embodiment, the second portion 1714 may be advanced into the container 1612 to urge the sealant 1708 out of the container 1612.

FIG. 30 illustrates a collated fastener 3000 in which a head 3002 of the collated fastener 3000 may be advanced through the container 1612 to urge the sealant 1708 out of the container 1612. For example, rather than the container 1612 becoming compressed between the washer 1710 and the bracket 1602, for example, as described above, when the collated fastener 3000 is secured into the surface 1604, the container 1612 may be removed and/or separated from the collated fastener 3000. For example, the container 1612 may be removed with the strip 1608.

More particularly, at “1” in FIG. 30, the head 3002 may be disposed external to the container 1612. Additionally, the washer 1710 may be disposed below the strip 1608 and/or the container 1612 may be disposed above the strip 1608. As the collated fastener 3000 is driven into the surface 1604, the sealant 1708 within the container 1612 may wrap around the surface 1604 and advanced into the surface 1604. As shown at “2” in FIG. 30, when the collated fastener 3000 is driven into the surface 1604, the head 3002 of the collated fastener 3000 may advance through the cavity 1808 of the container 1612. During this movement, the head 3002 may, in an embodiment, assist in pushing the sealant 1708 out of the container 1612. As the collated fastener 3000 is further secured into the surface 1604, the head 3002 of the collated fastener 3000 may advance through the second opening 1812 or push through the container 1612 at the second end 1802 and/or the receptacle 1900, thereby separating from the strip 1608 and the container 1612.

Although certain embodiments of the collated fasteners are shown in FIGS. 25-30, other variations are envisioned. As a non-limiting example, the strip 1608 in FIG. 25 may be disposed above the container 1612, proximate to the head 1700.

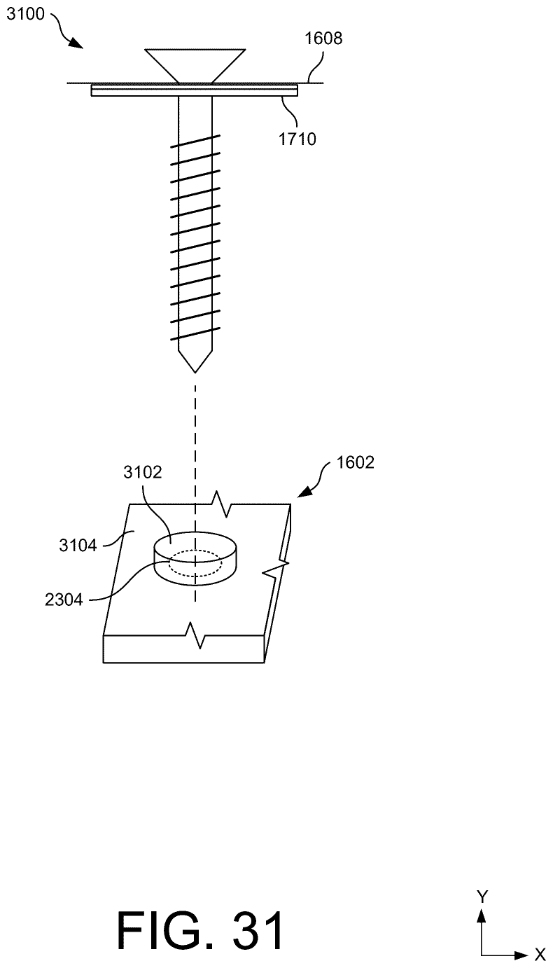

FIG. 31 illustrates a collated fastener 3100 that is used in conjunction with a sealant 3102 pre-applied to the bracket 1602, according to an embodiment of the present disclosure. For example, the bracket 1602 may include the aperture 2304, and the sealant 3102 may be pre-applied adjacent to the aperture 2304, such as on a top surface 3104 of the bracket 1602. The sealant 3102 may be pre-applied in any shape, such as a puck, glob, etc. Moreover, the sealant 3102 may be an adhesive sealant, a liquid sealant, etc.

As the collated fastener 3108 advances into the sealant 3102 and into the aperture 2304, the sealant 3102 may become adhered to the collated fastener 3100 (e.g., entwined in the threads 1704) and drawn into the surface 1604 to provide the water-tight seal. The washer 1710 may be disposed beneath the strip 1608 to further provide a seal over the aperture 2304 and prevent and ingress of liquid into the holes created in the surface 1604.

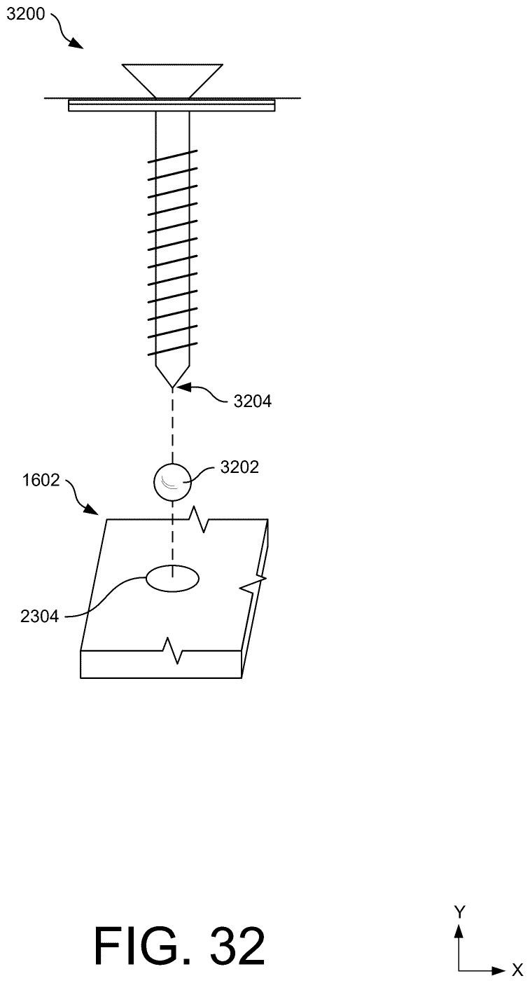

FIG. 32 illustrates a collated fastener 3200 that is used in conjunction with a sealant 3202 that is pre-applied to the bracket 1602 and/or the collated fastener 3200, according to an embodiment of the present disclosure. For example, before securing the collated fastener 3200 into the surface 1604, a glob, piece, etc., of the sealant 3202 may be placed in the aperture 2304, disposed on a tip 1702 of the collated fastener 3200, etc. The sealant 3202 may be retrieved from a bag, box, etc.

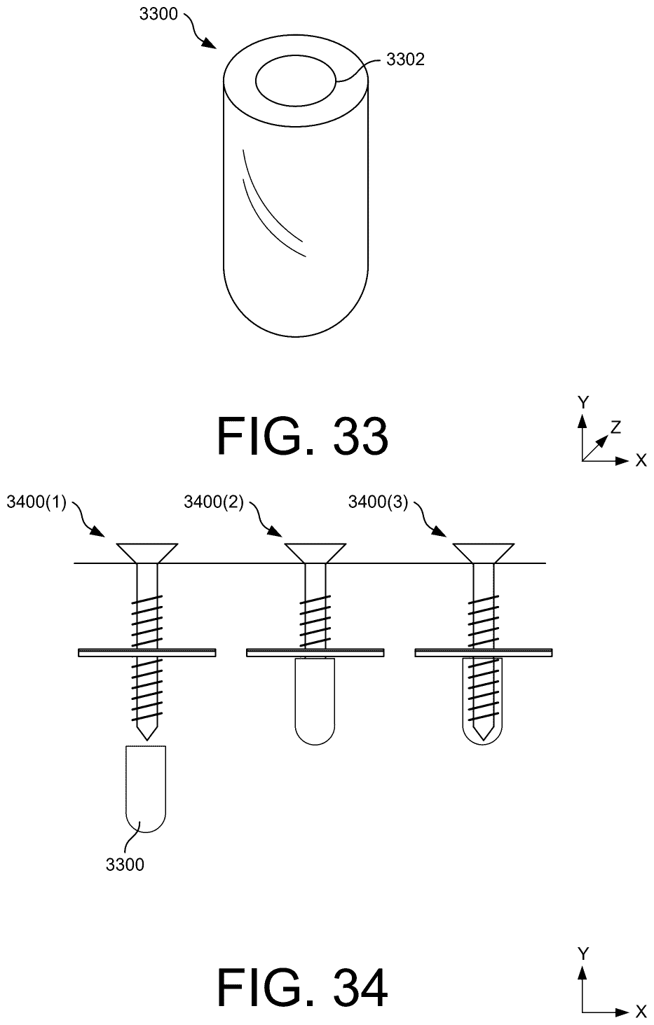

FIG. 33 illustrates an example sealant 3300 that may be pre-applied to a collated fastener, according to an embodiment of the present disclosure. In an embodiment, the sealant 3300 may include a channel 3302 that is inserted onto a tip of the collated fastener. For example, the sealant 3300, which may be in the form of a cap, plug, etc., may be slid or pressed onto the tip of the collated fastener. From there, once applied, the collated fastener may be secured into the surface 1604.

FIG. 34 illustrates an attachment of the sealant 3300 to collated fasteners 3400, according to an embodiment of the present disclosure. For example, before installation of the collated fasteners 3400 into the surface 1604, the sealant 3300 may be retrieved (e.g., from a box, etc.) and slid onto the tip of the collated fastener 3400. A first collated fastener 3400(1) is shown having the sealant 3300 being absent, such as before the sealant 3300 is pushed or push over the tip (e.g., end) of the first collated fastener 3400(1). A second collated fastener 3400(2) and a third collated fastener 3400(2) are shown having the sealant 3300 being applied. The sealant 3300 on the second collated fastener 3400(3) is shown as transparent. The sealant 3300 may extend by any amount up the body of the collated fasteners 3400. However, by disposing at the tip, the sealant 3300 may be drawn into the holes created in the surface 1604.

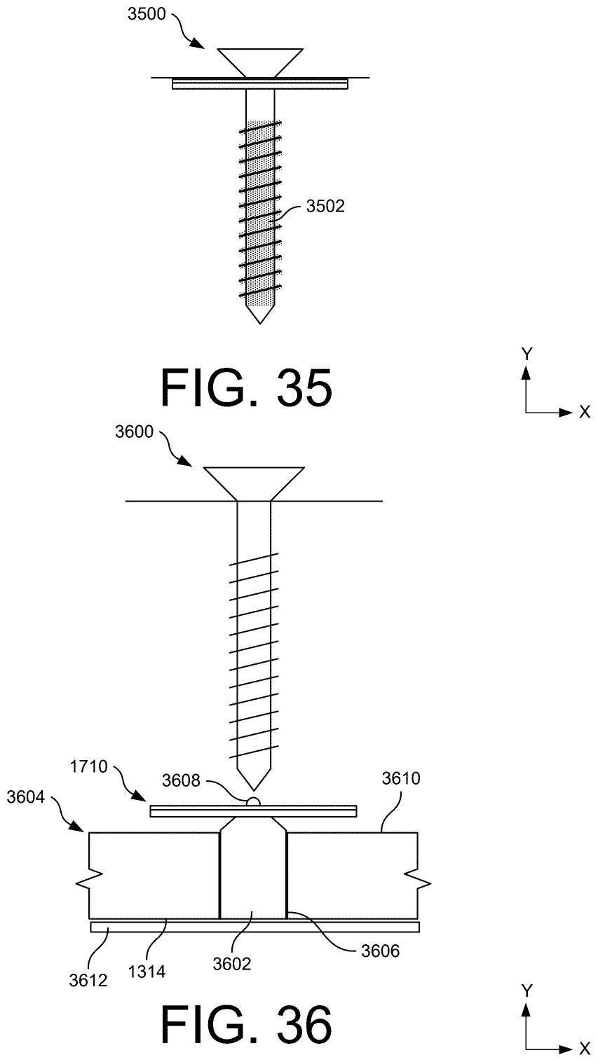

FIG. 35 illustrates a collated fastener 3500 having a sealant 3502 pre-applied to the collated fastener 3500, according to an embodiment of the present disclosure. For example, in an embodiment, the sealant 3502 may be pre-applied to the collated fastener 3500, whether in the form of spraying, coating, dipping, etc. In an embodiment, the sealant 3502 may represent microspheres that, under pressure, release the sealant 3502 to seal around the collated fastener 3500. In an embodiment, the microspheres may be two-part epoxies, heat activated (e.g., via friction with the surface 1604), etc.

FIG. 36 illustrates a collated fastener 3600 used in conjunction with a sealant 3602 pre-applied to a bracket 3604, according to examples of the present disclosure. The bracket 3604 may be similar to the bracket 1602. The sealant 3602 may be pre-applied within an aperture 3606 of the bracket 3604. In an embodiment, the sealant 3602 may include a nipple 3608 on which the washer 1710 rests or is disposed. In an embodiment, the washer 1710 may be spaced above a top surface 3610 of the bracket 3604, or may be disposed on the top surface 3610. A membrane 3612 may be disposed beneath a bottom surface 3614, opposite of the top surface 3610, to prevent the sealant 3602 from inadvertently adhering to other objects before installation. The membrane 3612 may be removed before the collated fastener 3600 is installed. The membrane 3612 may be applied across an entirety of the bottom surface 3614, or adjacent to the aperture 3606.

In an embodiment, the nipple 3608 may be omitted. Instead, the washer 1710 may be disposed adjacent to the strip 1608 or along the body of the collated fastener 3600.

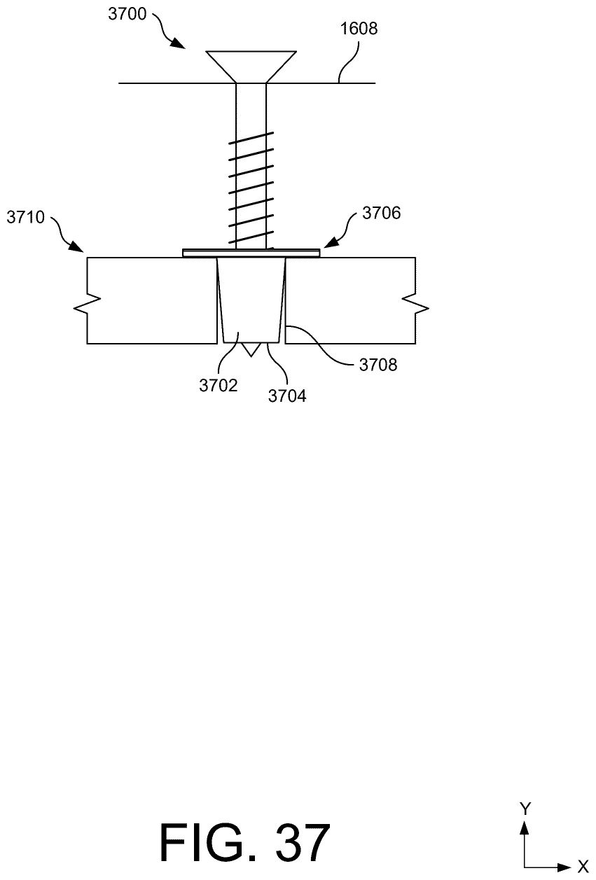

FIG. 37 illustrates a collated fastener 3700 with a sealant 3702 that is pre-applied, according to an embodiment of the present disclosure. The sealant 3702 may be disposed within a container 3704 through which a portion of the collated fastener 3700 is disposed. In addition, the collated fastener 3700 may be disposed through the washer 3706, which is disposed vertically above the container 3704. As shown, the container 3704 may be sized to be disposed within an aperture 3708 of a bracket 3710. The bracket 3710 may be similar to the other brackets described herein. The container 3704 may remain in the aperture 3708 after the collated fastener 3700 is separated from the strip 1608. Although the container 3704 is shown as a certain shape (e.g., conical), other shapes are envisioned (e.g., cylindrical). In an embodiment, a height of the container 3704 (e.g., in the Y-direction) may be less than a depth of the aperture 3708 (e.g., in the Y-direction) such that the washer 1710 may seal against the bracket 3710 to prevent an ingress of liquid into the aperture 3708, for example.

In an embodiment, the container 3704 may be open at a bottom, adjacent to the surface 1604. A release paper may be disposed on a portion of the sealant 3702 that is accessible via the bottom of the container 3704 to prevent the sealant 3702 from inadvertently adhering to other objects before installation. In an embodiment, the feed mechanism 1614 of the screw gun 1610 may remove the release paper from the bottom during installation.

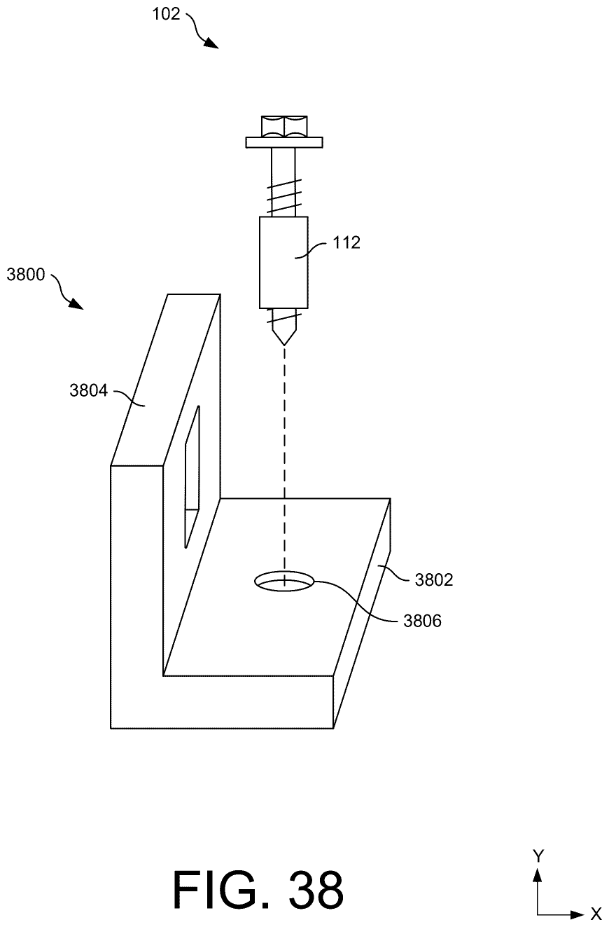

FIG. 38 illustrates an example bracket 3800, according to an embodiment of the present disclosure. Compared to the brackets as previously described herein (e.g., the bracket 100), which may resemble a “T” shaped bracket, the bracket 3800 may resemble an “L” shaped bracket. However, other shaped brackets, such as brackets that are “Z” shaped, “C” shaped, “U” shaped, etc., may be used.

The bracket 3800 may include a base 3802 and a stanchion 3804 that extends from the base 3802. The bracket 3800 may have an aperture 3806 disposed through the base 3802. Compared to the other brackets described herein, the bracket 3800 may have a single aperture 3806

The bracket 3800 may be usable with the fasteners as described herein. For example, the fastener 102 may be usable with the bracket 3800, where the fastener 102 has the sealant 112 pre-applied along a length of the fastener 102. The fastener 102 may be disposed through the aperture 3806 and into the surface. Alternatively, rather than being used in conjunction with the sealant 112, the sealant 112 may be pre-applied to the bracket 3800, proximate the aperture 3806. This may be similar to the embodiment of the bracket 1000 in FIG. 10, whereby the sealant is pre-applied to the bracket 3800. Moreover, the bracket 3800 may be used in conjunction with the collated fasteners.

As used herein, terms such as “attached,” “fastened,” “secured,” “disposed,” “connected,” and “coupled” (including variations thereof) are intended to be used interchangeably to refer to any form of interaction between components, whether directly or indirectly, permanently or temporarily, mechanically or otherwise. It will be understood that these terms are not intended to limit the nature of the interaction to a direct or immediate connection unless specifically stated, and may include indirect connections through one or more intermediary elements. Likewise, the terms “directly” and “indirectly” describe both physical contact between components and connections made through intermediate structures, mechanisms, or devices.

While various examples and embodiments are described individually herein, the examples and embodiments may be combined, rearranged, and modified to arrive at other variations within the scope of this disclosure.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A fastener to secure a bracket to a surface, the fastener comprising:
a body; and
a sealant at least partially disposed along a length of the body, the sealant being configured to seal a penetration formed in the surface during securement of the bracket to the surface.

2. The fastener of claim 1, wherein the sealant includes at least one of butyl, silicone, acrylic, polyurethane, or rubber.

3. The fastener of claim 1, wherein the sealant is pre-applied to the length of the body prior to the securement of the bracket to the surface.

4. The fastener of claim 1, wherein the sealant is applied to the body via at least one of spraying, dipping, coating, or adhering.

5. The fastener of claim 1, wherein the sealant includes microspheres that are configured to fracture during the securement of the bracket to the surface to seal the penetration.

6. The fastener of claim 1, wherein the length of the body includes threads.

7. A fastener comprising:
a body;
a sealant at least partially disposed along a length of the body; and
a washer secured to the body, the washer including:
a first portion formed of a first material, and
a second portion formed a second material.

8. The fastener of claim 7, wherein:
the first portion includes metal; and
the second portion includes ethylene-propylene diene monomer.

9. The fastener of claim 7, wherein the fastener is secured to a strip containing a plurality of fasteners.

10. The fastener of claim 9, wherein the fastener is secured to the strip at a location vertically below a head of the fastener, and vertically above the sealant.

11. The fastener of claim 7, wherein the sealant includes at least one of butyl, silicone, acrylic, polyurethane, or rubber.

12. The fastener of claim 7, wherein the sealant is configured to seal a penetration formed in a surface during securement of the fastener into the surface.

13. An assembly comprising:
a strip including a plurality of receptacles;
a plurality of fasteners attached to the strip, wherein individual fasteners of the plurality of fasteners are disposed at least partially within individual receptacles of the plurality of receptacles; and
a sealant disposed along a portion of a length of the individual fasteners of the plurality of fasteners.

14. The assembly of claim 13, further comprising a plurality of washers, wherein individual washers of the plurality of washers are secured to the individual fasteners.

15. The assembly of claim 14, wherein the individual washers include:
a first portion formed of a first material, and
a second portion formed of a second material.

16. The assembly of claim 13, further comprising a plurality of containers in which the sealant is disposed, wherein the individual fasteners are at least partially disposed within individual containers of the plurality of containers.

17. The assembly of claim 16, wherein the plurality of containers are attached to the strip.

18. The assembly of claim 13, wherein the individual fasteners attach to the strip proximate to a head of the individual fasteners.

19. The assembly of claim 13, wherein:
the plurality of fasteners are configured to attach to a surface; and
when attached to the surface, the plurality of fasteners separate from the strip.

20. The assembly of claim 13, wherein the sealant includes at least one of butyl, silicone, acrylic, polyurethane, or rubber.
